(19) United States
(12) Patent Application Publication
(10) Pub. No.: US 2016/0084462 A1
(43) Pub. Date: Mar. 24, 2016

(54) VEHICLE HEADLIGHT MODULE, VEHICLE HEADLIGHT UNIT, AND VEHICLE HEADLIGHT DEVICE

(71) Applicant: MITSUBISHI ELECTRIC CORPORATION, Tokyo (JP)

(72) Inventors: Masashige SUWA, Tokyo (JP); Ritsuya OSHIMA, Tokyo (JP); Muneharu KUWATA, Tokyo (JP); Kuniko KOJIMA, Tokyo (JP)

(73) Assignee: MITSUBISHI ELECTRIC CORPORATION, Tokyo (JP)

(21) Appl. No.: 14/786,940

(22) PCT Filed: Apr. 24, 2014
(86) PCT No.: PCT/JP2014/002293

§ 371 Date: Oct. 23, 2015

(30) Foreign Application Priority Data
Apr. 26, 2013 (JP) 2013-094053

(51) Int. Cl. F21S 8/10

(52) U.S. Cl. CPC F21S 48/1241; F21S 48/125; F21S 48/1721; F21S 48/145

(57) ABSTRACT

A vehicle headlight module includes: a light source that emits light that becomes illumination light; a light guide component having an incident surface through which the light emitted from the light source enters the light guide component as incident light, a side surface that reflects the incident light to superpose beams of the incident light, and an emitting surface from which the reflected incident light is emitted; and a projection lens that projects the light emitted from the emitting surface. The light guide component has an inclined surface in the side surface. A part of the incident light that has been reflected by the inclined surface is superposed with another part of the incident light that has not been reflected by the inclined surface in a partial region on the emitting surface, so that a luminance of the partial region is higher than a luminance of the other region.

### TECHNICAL FIELD

The present invention relates to a vehicle headlight module and a vehicle headlight device that irradiates an area in front of a vehicle.

### BACKGROUND ART

From the viewpoint of reducing the burden on the environment, such as reducing emission of CO₂ and consumption of fuel, it is desired to improve energy efficiency of vehicles. Along with this, in vehicle headlights, downsizing and weight reduction are required, and improvement of power efficiency is also required. Thus, it is desired to employ, as light sources of vehicle headlights, semiconductor light sources having high luminous efficiency as compared to conventional halogen bulbs. “Semiconductor light source” refers to, for example, a light emitting diode (referred to below as an LED), a laser diode, or the like. “Vehicle headlight” refers to an illuminating device that is mounted on a transportation machine or the like and used to improve visibility for an operator and conspicuity to the outside. It is also referred to as a headlamp or headlight.

A conventional vehicle headlight employing a lamp light source employs an optical system based on the assumption that the lamp light source is a point light source. However, actually, the light emitting source of the lamp light source has a finite size. Therefore, an optical system designed on the assumption that the lamp light source is an ideal point light source has a low light use efficiency or a low vehicle headlight performance. Further, for example, when an LED is used as the light source, since the amount of emitted light per unit area of an LED is small as compared to a conventional lamp light source, it is necessary to increase the size of the light source (LED) in order to obtain the same light amount as that of the lamp light source. Thus, if the above-described optical system for the lamp light source is employed on the assumption that the LED is a point light source, the light use efficiency further decreases. The vehicle headlight performance also decreases. Thus, since any light source has a finite size, an optical system different from those of conventional vehicle headlights is necessary to reduce reduction of light use efficiency of a vehicle headlight. “Light use efficiency” refers to usage efficiency of light. Specifically, it is a ratio of the amount of light actually illuminating an illumination area to the amount of light emitted by a light source.

Further, a conventional lamp light source (bulb light source) is a light source having lower directivity than a semiconductor light source. Thus, a lamp light source uses a reflecting mirror (reflector) to give directivity to the emitted light. On the other hand, a semiconductor light source has at least one light emitting surface and emits light to the light emitting surface side. In this manner, a semiconductor light source is different from a lamp light source in light emitting characteristics, and therefore requires an optical system suitable for a semiconductor light source instead of a conventional optical system using a reflecting mirror.

From the above-described characteristics of a semiconductor light source, for example, a light source of the present invention, described later, may include an organic electroluminescence (organic EL) light source that is a type of solid-state light sources. Also, for example, the light source of the present invention, described later, may include a light source that irradiates phosphor applied on a plane with excitation light to cause the phosphor to emit light.

Excluding bulb light sources, light sources having directivity are referred to as “solid-state light sources.” “Directivity” refers to a property that the intensity of light or the like emitted into space varies with direction. “Having directivity” here indicates that light travels to the light emitting surface side and does not travel to the side opposite to the light emitting surface, as described above. Thus, the divergence angle of light emitted from the light source is typically 180 degrees or less. Thus, the need for a reflecting mirror such as a reflector can be eliminated.

Further, as one of the properties that a vehicle headlight needs to satisfy, there is a predetermined light distribution pattern specified by road traffic rules or the like. “Predetermined” here refers to being previously specified by road traffic rules or the like. “Light distribution” refers to a luminous intensity distribution of a light source with respect to space, i.e., a spatial distribution of light emitted from a light source. For example, a predetermined light distribution pattern for an automobile low beam has a horizontally long shape narrow in the up-down direction. Further, to prevent an oncoming vehicle from being dazzled, a boundary (cutoff line) of light on the upper side of the light distribution pattern is required to be sharp. Specifically, a sharp cutoff line with a dark area above the cutoff line (outside the light distribution pattern) and a bright area below the cutoff line (inside the light distribution pattern) is required. “Cutoff line” here refers to a light/dark borderline formed on the upper side of the light distribution pattern when a wall or screen is irradiated with light from a vehicle headlight, i.e., a light/dark borderline on the upper side of the light distribution pattern. Cutoff line is a term used when an irradiating direction of a headlight for passing each other is adjusted. The headlight for passing each other is also referred to as a low beam. “Sharp cutoff line” indicates that large chromatic aberration must not occur in the cutoff line. Further, for identification of pedestrians and signs, it needs to have a “rising line” along which the irradiation on a walkway side rises. Further, it is required that the luminous intensity is highest near and below the cutoff line (inside the light distribution pattern). Thus, it is required that the luminous intensity is highest in a region on the lower side of the cutoff line (inside the light distribution pattern). “Rising line along which the irradiation rises” here refers to a shape of a light distribution pattern of a low beam that is horizontal on an oncoming vehicle side and obliquely rises on a walkway side. This is in order to visually recognize people, signs, or the like on the walkway side without dazzling oncoming vehicles. The “low beam” is a downward beam and used in passing an oncoming vehicle or the like. Typically, the low beam illuminates about 40 m ahead. “Up-down direction” refers to a direction perpendicular to the ground surface. A vehicle headlight needs to realize this complicated light distribution pattern. “Luminous intensity” indicates the degree of intensity of light emitted by a luminous body and is obtained by dividing the luminous flux passing through a small solid angle in a given direction by the small solid angle.

To achieve such a complicated light distribution pattern, a configuration using a polyhedral reflector, a light blocking plate, or the like is commonly used. This complicates the configuration of the optical system. Further, the use of a light blocking plate or the like reduces the light use efficiency. In general, downsizing of an optical system reduces the light use efficiency. Thus, it is necessary to achieve a small-sized optical system having high light use efficiency. Hereinafter, use efficiency of light will be referred to as “light use efficiency.”

Patent Reference 1 discloses a technique of a vehicle headlight using a semiconductor light source. Patent Reference 1 discloses a technique in which a semiconductor light source is disposed at a first focal point of a reflector with an ellipsoid of revolution, light emitted from the semiconductor light source is concentrated at a second focal point, and parallel light is emitted by a projection lens.

### PRIOR ART REFERENCES

### Patent References

Patent Reference 1: Japanese Patent Application Publication No. 2009-199938

### SUMMARY OF THE INVENTION

### Problems to be Solved by the Invention

However, in the configuration of Patent Reference 1, since the semiconductor light source is not a point light source, it is difficult to emit light as parallel light. Further, since the reflector is used, the optical system is large. Further, since the configuration of Patent Reference 1 forms the cutoff line using a light blocking plate, the light use efficiency is low.

The present invention is made in view of the problems of the prior art, and is intended to provide a small-sized vehicle headlight that uses a light source, such as a solid-state light source, having an finite size and reduces the reduction of the light use efficiency.

### Means for Solving the Problems

A vehicle headlight module includes: a light source that emits light that becomes illumination light; a light guide component having an incident surface through which the light emitted from the light source enters the light guide component as incident light, a side surface that reflects the incident light to superpose beams of the incident light, and an emitting surface from which the reflected incident light is emitted; and a projection lens that projects the light emitted from the emitting surface, wherein the light guide component has an inclined surface in the side surface, and wherein a part of the incident light that has been reflected by the inclined surface is superposed with another part of the incident light that has not been reflected by the inclined surface in a partial region on the emitting surface, so that a luminance of the partial region is higher than a luminance of the other region.

### Effect of the Invention

According to the present invention, it is possible to provide a vehicle headlight that uses a solid-state light source and reduces the increase in size of an optical system and the reduction of the light use efficiency.

### BRIEF DESCRIPTION OF THE DRAWINGS

FIG. 1 is a configuration diagram illustrating a configuration of a vehicle headlight module 1 in a first embodiment.

FIG. 2 is a perspective view of a light guide component 3 in the first embodiment.

FIG. 3 is a diagram illustrating a simulation result of the luminous intensity distribution on an emitting surface 32 in the first embodiment.

FIG. 4 is a schematic diagram illustrating a shape of the emitting surface 32 of the light guide component 3 in the first embodiment.

FIG. 5 is a perspective view of a light guide component 30 in the first embodiment.

FIG. 6 is a diagram illustrating a simulation result of the luminous intensity distribution on the emitting surface 32 in the first embodiment.

FIG. 7 is a configuration diagram illustrating a configuration of a vehicle headlight module 10 in a second embodiment.

FIG. 8 is an explanatory diagram illustrating how light travels in a light guide component 300 with a tapered shape in the second embodiment.

FIG. 9 is a configuration diagram illustrating a configuration of a vehicle headlight module 100 in a third embodiment.

FIG. 10 is a schematic diagram illustrating a light distribution pattern 103 of a motorcycle in the third embodiment.

FIG. 11 is a diagram illustrating an tilt angle k of a vehicle body in the third embodiment.

FIG. 12 is a schematic diagram illustrating a case where a light distribution pattern is corrected by the vehicle headlight module 100 in the third embodiment.

FIG. 13 is a configuration diagram illustrating a configuration of a vehicle headlight module 110 in a fourth embodiment.

FIG. 14 is a diagram illustrating an irradiated area when a vehicle having the vehicle headlight module 110 in the fourth embodiment corners.

FIG. 15 is a configuration diagram illustrating a configuration of a vehicle headlight module 120 in a fifth embodiment.

FIG. 16 is a configuration diagram illustrating a configuration of a vehicle headlight module 121 in a fifth embodiment.

FIG. 17 is a configuration diagram illustrating a configuration of a vehicle headlight device 130 in a sixth embodiment.

FIG. 18 is a schematic diagram illustrating irradiated areas 113 and 123 on an irradiated surface irradiated by the vehicle headlight device 130 in a sixth embodiment.

FIG. 19 is a configuration diagram illustrating a configuration of a vehicle headlight unit 140 in a seventh embodiment.

FIG. 20 is a schematic diagram for explaining a motion of a cover shade 79 in the seventh embodiment.

### MODES FOR CARRYING OUT THE INVENTION

Embodiments of the present invention will be described below with reference to the drawings. In the following description of the embodiments, to facilitate explanation, xyz-coordinates will be used. It will be assumed that a left-right direction of a vehicle is the x axis direction; the right direction with respect to a forward direction of the vehicle is the +x axis direction; the left direction with respect to the forward direction of the vehicle is the −x axis direction. Here, “forward direction” refers to a traveling direction of the vehicle. It will be assumed that an up-down direction of the vehicle is the y axis direction; the upward direction is the +y axis direction; the downward direction is the −y axis direction. The upward direction is a direction toward the sky; the downward direction is a direction toward the ground. It will be assumed that the traveling direction of the vehicle is the z axis direction; the traveling direction is the +z axis direction; the opposite direction is the −z axis direction. The +z axis direction will be referred to as the forward direction; the −z axis direction will be referred to as the backward direction.

As described above, the light source of the present invention is a light source having directivity. The main example is a semiconductor light source, such as a light emitting diode or a laser diode. The light source of the present invention also includes an organic electroluminescence light source, a light source that irradiates phosphor applied on a plane with excitation light to cause the phosphor to emit light, and the like. The light source of the present invention does not include bulb light sources, such as an incandescent lamp, a halogen lamp, and a fluorescent lamp, that has no directivity and requires a reflector or the like. Excluding bulb light sources, light sources having directivity are referred to as “solid-state light sources.”

The present invention is applicable to a low beam, a high beam, or the like of a vehicle headlight. The present invention is also applicable to a low beam, a high beam, or the like of a motorcycle headlight. The present invention is also applicable to other vehicle headlights. For example, the present invention is applicable to a low beam, a high beam, or the like of a headlight for a motor tricycle. The motor tricycle is, for example, a motor tricycle called a gyro. “Motor tricycle called a gyro” refers to a scooter with three wheels including one front wheel and two rear wheels about one axis. In Japan, it corresponds to a motorbike. It has a rotational axis near the center of the vehicle body and allows most of the vehicle body including the front wheel and a driver seat to be tilted in the left-right direction. This mechanism allows the center of gravity to move inward during turning similarly to a motorcycle. As such, the present invention is also applicable to headlights for other vehicles, such as three-wheelers or four-wheelers. However, in the following description, a case where a light distribution pattern of a low beam of a motorcycle headlight is formed will be described. The light distribution pattern of the low beam of the motorcycle headlight has a cutoff line that is a straight line parallel to the left-right direction (x axis direction) of the vehicle, and is brightest in a region on the lower side of the cutoff line (inside the light distribution pattern).

“Horizontal plane” refers to a plane parallel to a road surface. A typical road surface may be inclined with respect to the traveling direction of the vehicle. It is an uphill, a downhill, or the like. In these cases, the “horizontal plane” is inclined toward the traveling direction of the vehicle. Thus, it is not a plane perpendicular to the direction of gravity. However, a typical road surface is seldom inclined in the left-right direction with respect to the traveling direction of the vehicle. “Left-right direction” refers to a width direction of a road. The “horizontal plane” is a plane perpendicular to the direction of gravity in the left-right direction. For example, even if a road surface is inclined in the left-right direction and the vehicle is upright with respect to the road surface in the left-right direction, this is equivalent to a state in which the vehicle is tilted with respect to the “horizontal plane” in the left-right direction. To simplify explanation, the following description will be made on the assumption that the “horizontal plane” is a plane perpendicular to the direction of gravity.

### First Embodiment

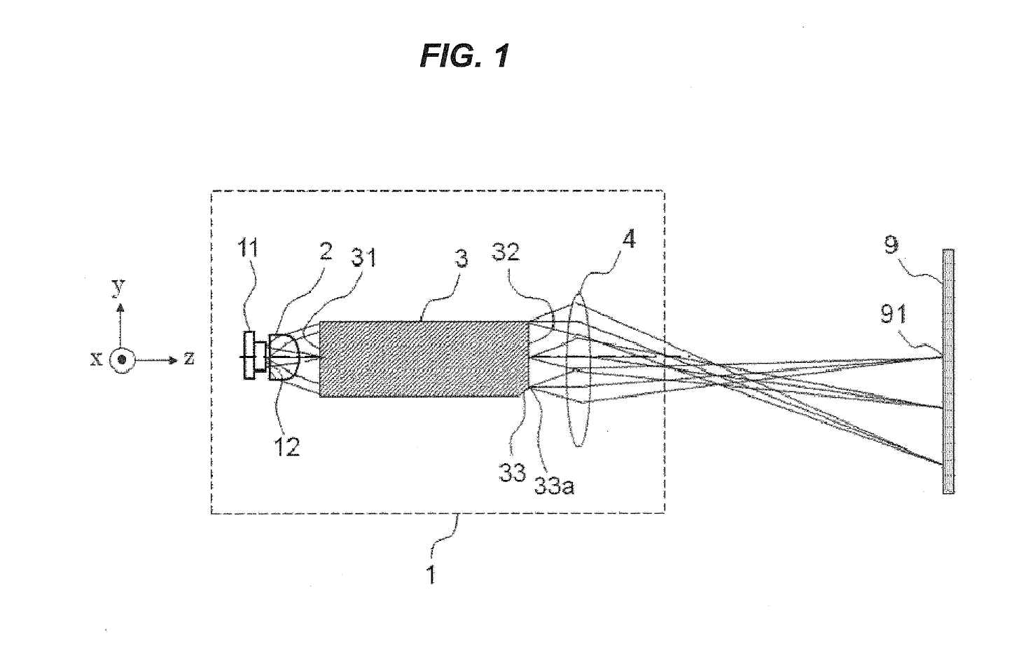

FIG. 1 is a configuration diagram illustrating a configuration of a vehicle headlight module 1 according to a first embodiment of the present invention. As illustrated in FIG. 1, the vehicle headlight module 1 according to the first embodiment includes a light source 11, a light guide component 3, and a projection lens 4. The vehicle headlight module 1 may also include a light distribution control lens 2. The light source 11 has a light emitting surface 12. The light source 11 emits, from the light emitting surface 12, light for illuminating an area in front of the vehicle. An LED, an electroluminescence element, a semiconductor laser, or the like may be used as the light source 11. However, the following description illustrates a case where the light source 11 is an LED. Hereinafter, the light source 11 will also be referred to as the LED 11.

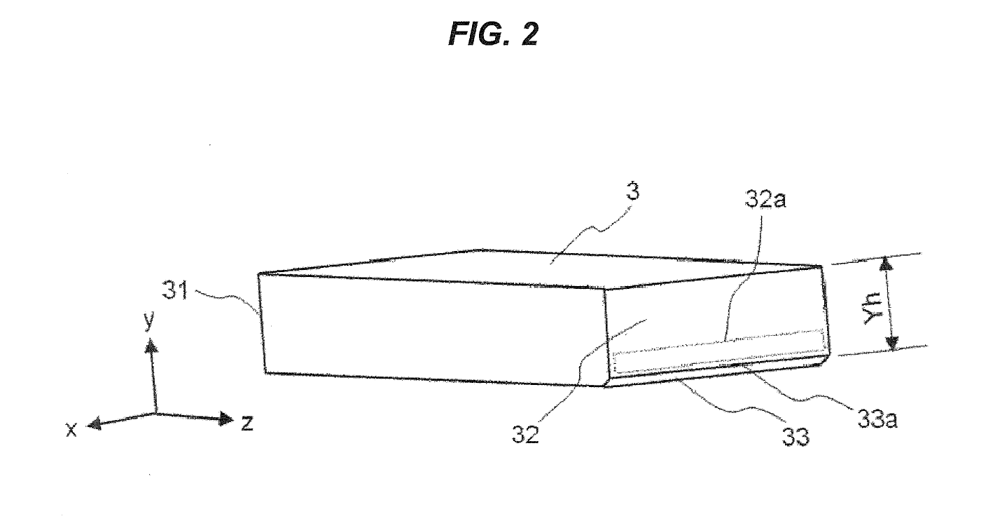

The light distribution control lens 2 is a lens having positive power. The light distribution control lens 2 makes the emission angle of the light emitted from the light emitting surface 12 equal to or less than 50 degrees with respect to a normal of the light emitting surface 12, for example. If the emission angle is 50 degrees, the divergence angle is 100 degrees. “Divergence angle” refers to the angle by which light spreads. The light guide component 3 has an incident surface 31 and an emitting surface 32. The incident surface 31 is a surface on which the light passing through the light distribution control lens 2 is incident. If the light distribution control lens 2 is not provided, the light emitted from the light emitting surface 12 enters the light guide component 3 through the incident surface 31. The light guide component 3 has a solid column shape. For example, the light guide component 3 illustrated in FIG. 2 has a column body shape with rectangular bases. “Column body” refers to a columnar spatial figure having two plane figures as bases. Surfaces of the column body other than the bases are referred to as side surfaces. The distance between the two bases of the column body is referred to as a height. One of the bases of the light guide component 3 is the incident surface 31 of light and the other base is the emitting surface 32 of light. On the emitting surface 32 side of the light guide component 3 illustrated in FIG. 2, an inclined surface 33 is formed. The projection lens 4 projects the light emitted from the emitting surface 32 of the light guide component 3 in front of the vehicle. “Project” refers to throwing light. “Irradiate” also refers to throwing light. Hereinafter, “project” and “irradiate” will be used interchangeably.

The light distribution control lens 2 is disposed immediately after the LED 11. “After” here refers to a side toward which the light emitted from the LED 11 travels. Here, “immediately after” indicates that the light emitted from the light emitting surface 12 is directly incident on the light distribution control lens 2. The light distribution control lens 2 is made of, for example, glass, silicone, or the like. The material of the light distribution control lens 2 may be any material having transparency, and may be transparent resin or the like. However, from the viewpoint of light use efficiency, materials having high transparency are appropriate as the material of the light distribution control lens 2. Since the light distribution control lens 2 is disposed immediately after the LED 11, the material of the light distribution control lens 2 preferably has excellent heat resistance. In FIG. 1, for the purpose of explanation of the configuration of the vehicle headlight module 1, a gap is provided between the light emitting surface 12 and the light distribution control lens 2, but they may be disposed almost without a gap.

Typically, the LED 11 emits a light beam in a Lambertian distribution. “Lambertian distribution” here refers to a distribution of light in the case of perfect diffusion, i.e., a distribution in which the luminance of the light emitting surface is constant regardless of the viewing direction. If a light source having a Lambertian distribution is employed, the emission angle of the light emitted from the light guide component 3 is up to approximately 90 degrees. Thus, the divergence angle is approximately 180 degrees. “Luminance” refers to the luminous intensity per unit area.

The light emitted at such a large angle causes large chromatic aberration after passing through the projection lens 4. In such a case, it is difficult to form the cutoff line of the low beam. As described above, the cutoff line of the low beam is specified in road traffic rules or the like.

The light distribution control lens 2 has a function of controlling an angle of the light beam emitted from the LED 11 to an angle larger than 0 degrees and equal to or smaller than 50 degrees with respect to the normal of the light emitting surface 12, for example. In this case, the divergence angle is equal to or smaller than 100 degrees. The light distribution control lens 2 makes the incident angle of the light incident on the light guide component 3 equal to or smaller than 50 degrees, which can reduce the emission angle of the light emitted from the emitting surface 32. Thus, the light distribution control lens 2 can reduce the chromatic aberration and form a sharp cutoff line.

FIG. 2 is a perspective view of the light guide component 3. For example, the light guide component 3 has a quadrangular prism shape, and the incident surface 31 and emitting surface 32 have rectangular shapes. The light guide component 3 is made of transparent resin. The cross-sectional shape of the light guide component 3 in a plane (the x-y plane) perpendicular to the traveling direction of the light is not limited to rectangular shapes. The light guide component 3 may have a cross-sectional shape similar to the shape of a desired light distribution pattern. “Desired” here refers to, for example, setting the cross-sectional shape of the light guide component 3 to a shape having the above-described “rising line.” The incident surface 31 should have an area capable of receiving the light emitted from the light distribution control lens 2. If the light distribution control lens 2 is not provided, it should have an area capable of receiving the light emitted from the light emitting surface 12. The emitting surface 32 preferably has the same shape as the light distribution pattern of the light emitted from the vehicle headlight module 1. This is because the emitting surface 32 and an irradiated surface 9 are at optically conjugate positions and thus the light distribution pattern on the irradiated surface 9 is the same as the light distribution pattern on the emitting surface 32. “Optically conjugate” refers to a relation in which light emitted from one point is imaged at another point. It is not necessary that the incident surface 31 and emitting surface 32 have the same shape. However, a case where the incident surface 31 and emitting surface 32 have the same rectangular shape will be described here.

Further, the light guide component 3 has, on the lower (−y axis direction) side of the emitting surface 32, the inclined surface 33. Specifically, the light guide component 3 has, at an end portion on the lower (−y axis direction) side of the emitting surface 32, the inclined surface 33. The inclined surface 33 has a shape obtained by obliquely cutting off a corner of a portion on the lower side of the emitting surface 32. Thus, it has a shape obtained by chamfering a side on the lower end side of the emitting surface 32. “Chamfering” refers to obliquely cutting off a corner or an edge of a work piece. It is not necessary that the inclined surface 33 is connected to a lower edge 33a of the emitting surface 32. It is only required that the inclined surface 33 is provided in a side surface of the light guide component 3 and reflects light to a lower end portion 32a. The lower end portion 32a corresponds to the above-described region on the lower side of the cutoff line (inside the light distribution pattern) having the highest luminous intensity. As viewed from the +x axis direction, the inclined surface 33 is a surface obtained by rotating a surface in the emitting surface 32 clockwise by an angle smaller than 90 degrees about the x axis as a rotational axis. The rotation angle is, for example, 45 degrees. The height of the inclined surface 33 in the y axis direction is, for example, 1.0 mm or less. Thus, the addition of the inclined surface 33 to the emitting surface 32 reduces the area of the emitting surface 32.

The light incident on the incident surface 31 propagates inside the light guide component 3 while being repeatedly totally reflected at an interface between the transparent resin and air. “Propagate” refers to transmitting and spreading. Here, it refers to traveling of light in the light guide component 3. The light that has propagated through the light guide component 3 is emitted from the emitting surface 32 with its light intensity distribution equalized. The light intensity distribution is equalized by reflecting light beams at the side surfaces of the light guide component 3 to fold and superpose the light beams. Thus, the light intensity distribution on the emitting surface 32 is more uniform than the light intensity distribution on the incident surface 31. In other words, the light guide component 3 receives light and emits light having a light intensity distribution with enhanced uniformity. The emitting surface 32 can be regarded as a secondary light source. “Secondary light source” refers to a surface light source.

An optical element such as the light guide component 3 is typically called a light equalizing element. As the incident light travels inside the light guide component 3 while being totally reflected, it becomes uniform light because of superposition of light beams due to folding of the light beams. However, in the light distribution pattern specified in road traffic rules or the like, the region on the lower side of the cutoff line has the highest luminous intensity, for example.

By providing the inclined surface 33 on the lower end side of the emitting surface 32, it is possible to increase the luminous intensity in a region on the lower side of the emitting surface 32. If the inclined surface 33 is not provided, light is emitted from a position of the emitting surface 32 corresponding to the position of the inclined surface 33. However, if the inclined surface 33 is provided, light incident on the inclined surface 33 is reflected and emitted from the lower end portion 32a. The lower end portion 32a is a portion of the emitting surface 32 immediately above (+y axis direction) the inclined surface 33. Thus, in the portion (lower end portion 32a) of the emitting surface 32 immediately above (+y axis direction) the inclined surface 33, light originally emitted from the portion and light reflected by the inclined surface 33 overlap each other, so that the amount of light emitted from the portion is increased as compared to the other portion of the inclined surface 33. That is, in the lower end portion 32a, light beams are superposed, and the amount of emitted light is increased as compared to the other portion (region) of the emitting surface 32.

An image on the emitting surface 32 is magnified and projected by the projection lens 4 onto the irradiated surface 9 in front of the vehicle. The irradiated surface 9 is set at a predetermined position in front of the vehicle. The predetermined position in front of the vehicle is a position at which the luminous intensity or illuminance of the vehicle headlight is measured, and is specified in road traffic rules or the like. For example, in Europe, United Nations Economic Commission for Europe (UNECE) specifies a position 25 m from a light source as the position at which the luminous intensity of an automobile headlight is measured. In Japan, Japanese Industrial Standards Committee (JIS) specifies a position 10 m from a light source as the position at which the luminous intensity is measured.

The projection lens 4 is a lens that is made of transparent resin or the like and has positive power. The projection lens 4 may be composed of one lens, or may be composed using multiple lenses. However, since the light use efficiency decreases as the number of lenses increases, it is desirably composed of one or two lenses. The material of the projection lens 4 is not limited to transparent resin, and is only required to be a refractive material having transparency.

The projection lens 4 is disposed so that its optical axis is located on the lower (−y axis direction) side of an optical axis of the light guide component 3. The optical axis is a line connecting centers of curvature of both surfaces of the lens. The optical axis of the light guide component 3 is a central axis of the light guide component 3. The central axis of the light guide component 3 is a line that passes through a center of the incident surface 31 and is perpendicular to the incident surface 31. The optical axis of the light guide component 3 typically coincides with an optical axis of the LED 11 and an optical axis of the light distribution control lens 2. If the length of the emitting surface 32 of the light guide component 3 in the y direction is assumed to be Yh, the projection lens 4 is arranged to be shifted by half (Yh/2) of the length Yh in the −y axis direction relative to the light guide component 3. This arrangement makes it possible to make the position of the cutoff line 91 on the irradiated surface 9 coincide with the height (position in the y axis direction) of a center of the LED 11 without tilting the entire vehicle headlight module 1. Of course, if the vehicle headlight module 1 is mounted at a tilt on the vehicle, the position at which the projection lens 4 is arranged may be changed depending on the tilt.

The light distribution pattern of the low beam of the motorcycle headlight has the cutoff line having a straight line shape parallel to the left-right direction (x axis direction) of the vehicle. Further, it is necessary that the light distribution pattern of the low beam of the motorcycle headlight is brightest in the region on the lower side of the cutoff line 91. Since the emitting surface 32 of the light guide component 3 and the irradiated surface 9 are in optically conjugate relation with each other, the lower edge 33a of the emitting surface 32 corresponds to the cutoff line 91 on the irradiated surface 9. Since the present invention projects the light distribution pattern on the emitting surface 32 directly onto the irradiated surface 9, the light distribution on the emitting surface 32 is projected as it is. Thus, to achieve a light distribution pattern that is brightest in the region on the lower side of the cutoff line 91, it is necessary that, in the luminous intensity distribution on the emitting surface 32, the luminous intensity is highest in a region on the upper side (+y axis direction side) of the lower edge 33a of the emitting surface 32. That is, it is necessary that the luminous intensity in the lower end portion 32a is the highest on the emitting surface 32.

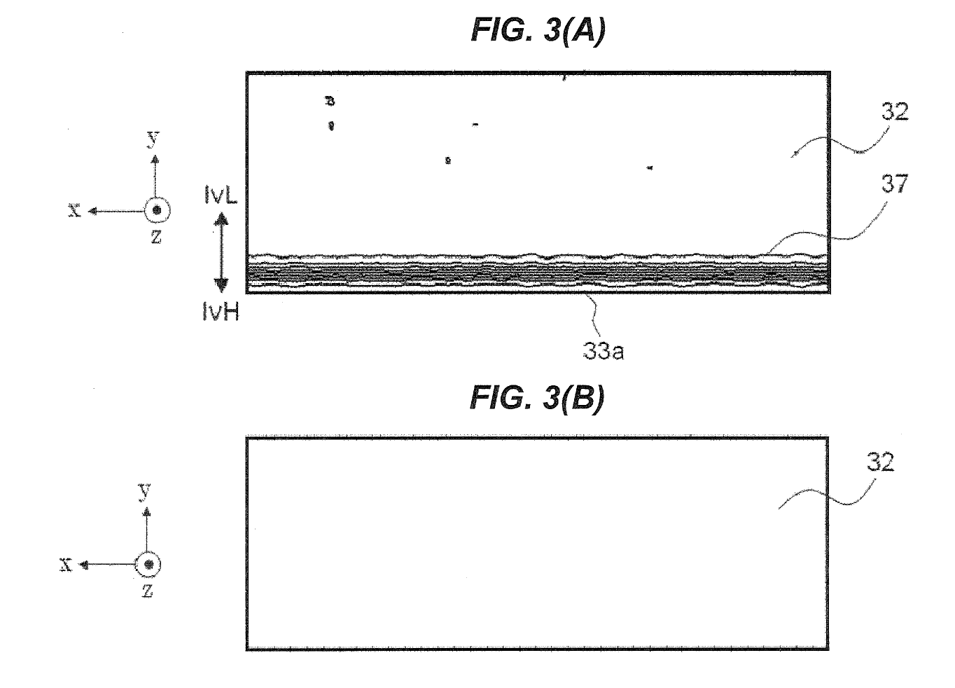

FIG. 3(A) is a diagram illustrating, in contour display, an example of simulation results of the luminous intensity distribution on the emitting surface 32 of the light guide component 3. The multiple lines parallel to the x axis depicted in the emitting surface 32 each represent a contour line 37 indicating the same luminous intensity. The luminous intensity on the emitting surface 32 increases from the +y axis direction side toward the −y axis direction side. The luminous intensity IvH is higher than the luminous intensity IvL. “Contour display” refers to displaying by means of a contour plot. “Contour plot” refers to a diagram depicting a line joining points of equal value. FIG. 3(B) is a diagram illustrating, in contour display, an example of simulation results of the luminous intensity distribution on the emitting surface 32 in a case where the inclined surface 33 is not provided in the light guide component 3. In FIG. 3(B), uniform light is emitted from the emitting surface 32. This is because the light propagates while being repeatedly totally reflected inside the light guide component 3 and thereby becomes uniform planar light on the emitting surface 32. On the other hand, in FIG. 3(A), on the upper side (+y axis direction side) of the lower edge 33a of the emitting surface 32, there is a region where the density of emitted light is high. The region where the density of light is high is the lower end portion 32a. That is, FIG. 3(A) shows that the luminous intensity in a region on the upper side (+y axis direction side) of the lower edge 33a is high. This is because the inclined surface 33 reflects light beams locally, thereby increasing the density of light emitted from the vicinity of the lower edge 33a.

In this manner, by providing the inclined surface 33 on the lower side of the emitting surface 32 of the light guide component 3, it is possible to provide the brightest region on the lower side of the cutoff line 91 while keeping the cutoff line 91 sharp. The vehicle headlight module 1 eliminates the need for using a light blocking plate, which leads to reduction of the light use efficiency, to form the cutoff line 91, like a conventional vehicle headlight. Further, the vehicle headlight module 1 does not require a complicated optical system configuration to provide a high illuminance region in the light distribution pattern. Thus, the vehicle headlight module 1 can realize a small and simple vehicle headlight with high light use efficiency. “Illuminance” refers to a value indicating the luminous flux incident per unit time on unit area of a surface illuminated by lighting.

A conventional vehicle headlight using a projection lens has a problem that chromatic aberration occurs near the cutoff line and thus the cutoff line cannot be formed sharply. The vehicle headlight module 1 according to the first embodiment of the present invention reduces, by means of the light distribution control lens 2, the angle of the light with respect to the optical axis to 50 degrees or less, for example. In this case, the light emitted from the light distribution control lens 2 is incident on the light guide component 3 at an incident angle of 50 degrees or less. The light that has propagated through the light guide component 3 is emitted from the emitting surface 32 at an emission angle of 50 degrees or less. This is because, if the side surfaces of the light guide component 3 are parallel to the optical axis, the incident angle of light incident on the light guide component 3 is equal to the emission angle of the light emitted from the light guide component 3. Since the light becomes planar light on the emitting surface 32 of the light guide component 3, the emitting surface 32 can be treated as a secondary light source. Chromatic aberration occurs if a lens greatly refracts light. By setting the emission angle of the light emitted from the emitting surface 32 to a small angle of 50 degrees or less, the chromatic aberration caused by the projection lens 4 can be drastically reduced.

Since the emission angle of the light emitted from the emitting surface 32 is 50 degrees or less, i.e., small, the light beam emitted from the emitting surface 32 is thin. Thus, the light distribution control lens 2 contributes to reduction of the aperture of the projection lens 4.

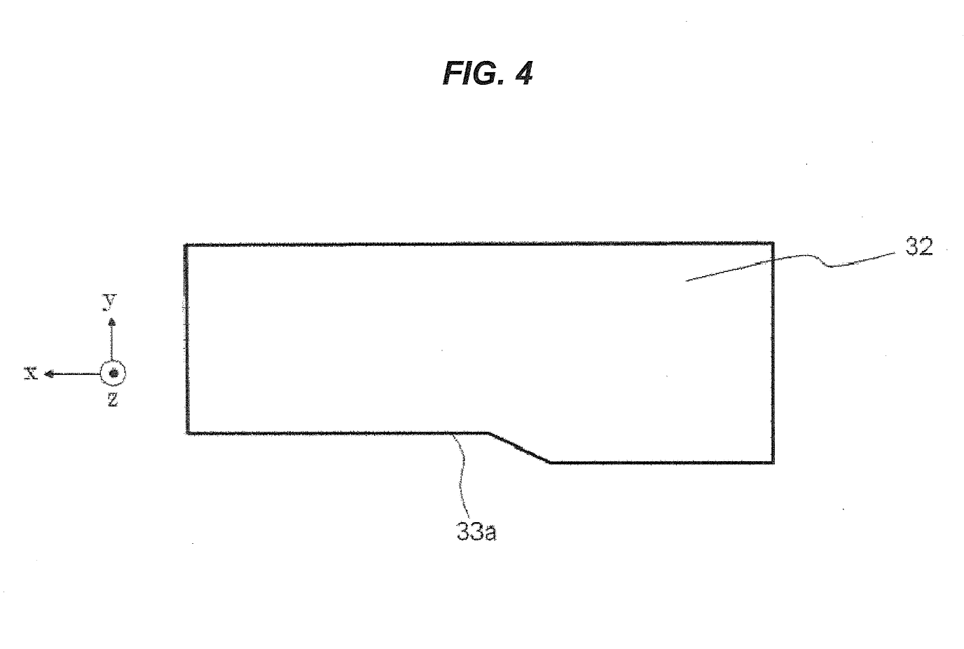

The vehicle headlight module 1 according to the first embodiment of the present invention describes a low beam of a motorcycle headlight device. However, the present invention is not limited to this. For example, it can be easily applied to a low beam of an automobile (four wheeler) headlight. FIG. 4 is a schematic diagram illustrating an example of the shape of the emitting surface 32 of the light guide component 3. The lower edge 33a of the emitting surface 32 may have a stepped shape as illustrated in FIG. 4, for example. In FIG. 4, the position in the y axis direction of a part of the lower edge 33a on the +x axis direction side is located on the +y axis direction side of the position in the y axis direction of a part of the lower edge 33a on the −x axis direction side. The two parts of the lower edge 33a are connected via a slant at a center in the x axis direction. Since the emitting surface 32 and the irradiated surface 9 are in optically conjugate relation with each other, a shape on the emitting surface 32 is projected onto the irradiated surface 9. Thus, by matching the shape of the emitting surface 32 with the shape of the light distribution pattern, it is possible to easily form the light distribution pattern. Further, the high illuminance region can be formed by providing a slope such as the inclined surface 33 at an edge portion of the lower edge 33a of the emitting surface 32 of the light guide component 3. The cutoff line 91 can be formed in the light distribution pattern on the irradiated surface 9. “Edge portion” refers to an edge of an object. Here, it indicates a portion at an edge of each surface of the light guide component 3, i.e., a portion at a side of each surface of the light guide component 3. “End portion” is used interchangeably with “edge portion.”

Some vehicles have an array of multiple vehicle headlight modules and add the respective light distribution patterns to form a desired light distribution pattern. “Desired” here refers to satisfying road traffic rules or the like. For the vehicle headlight module 1 according to the first embodiment, since the boundary of the light distribution pattern is sharp, arranging multiple vehicle headlight modules may emphasize the boundary and discomfort the driver. Hereinafter, a vehicle headlight in which multiple vehicle headlight modules are arranged will be referred to as a vehicle headlight device. In this case, for the boundary of the light distribution pattern, it is desirable that the luminous intensity should gradually decrease from a central part toward the boundary of the light distribution pattern. In such a case, it is desirable to provide the inclined surface 33 at an edge portion of the light guide component 3 corresponding to the boundary of the light distribution pattern so as to increase the area of the emitting surface 32. If a vehicle headlight device is composed of a single vehicle headlight module 1, the vehicle headlight module 1 is the vehicle headlight device.

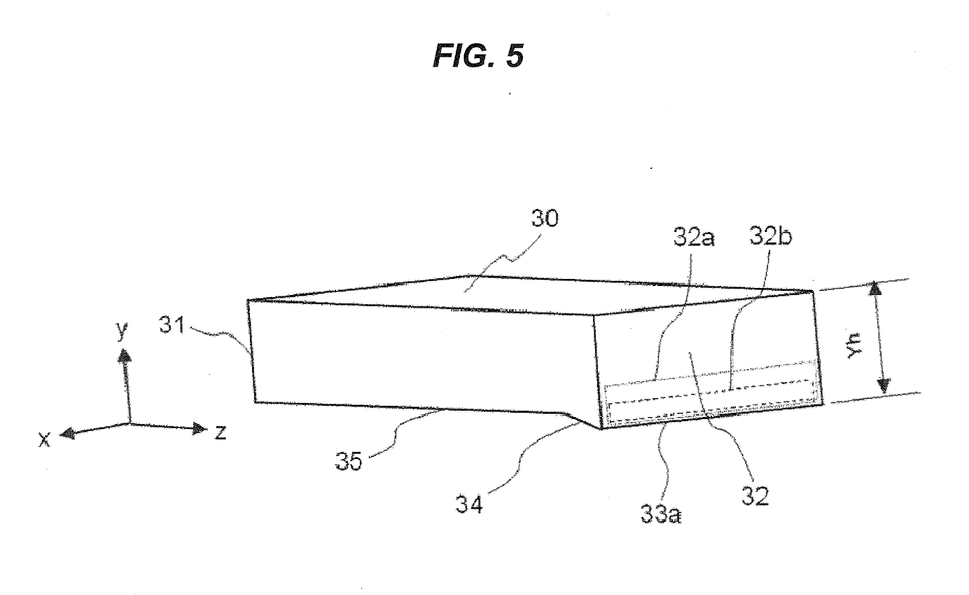

FIG. 5 is a perspective view illustrating an example of a light guide component 30 in which the luminous intensity gradually decreases from a central part toward a boundary of the light distribution pattern. In the light guide component 30, the boundary of the light distribution pattern corresponding to the lower edge 33a of the emitting surface 32 is fuzzy. Specifically, the light guide component 30 has a luminous intensity distribution in which the luminous intensity gradually decreases in the lower end portion 32a of the emitting surface 32 as compared to the central part of the emitting surface 32. An inclined surface 34 is provided in a lower surface 35 of the light guide component 30. “Lower surface” here refers to a surface on the −y axis direction side of the side surfaces of the light guide component 30. The lower surface 35 is a surface connected to the lower edge 33a of the emitting surface 32. The lower surface 35 is a side surface of the light guide component 30. Thus, the inclined surface 34 is provided in a surface connected to an edge portion of a portion where the luminous intensity is decreased in the emitting surface 32. The inclined surface 34 is provided at a position close to the emitting surface 32. “Close to” refers to existing near. Thus, “close to” does not require contact. The inclined surface 34 illustrated in FIG. 5 is disposed in contact with the lower edge 33a of the emitting surface 32. The inclined surface 34 is inclined so as to increase the area of the emitting surface 32. In the light guide component 30 illustrated in FIG. 5, light that should originally be reflected by the lower surface 35 of the light guide component 30 and emitted from the emitting surface 32 is emitted directly from an extended portion 32b of the emitting surface 32. This decreases the luminous intensity in the lower end portion 32a of the emitting surface 32. Specifically, a part of light emitted from the portion of the lower end portion 32a other than the extended portion 32b is emitted from the extended portion (region) 32b, and thereby the luminous intensity of the lower end portion 32a decreases. Thus, the luminance of the lower end portion 32a is lower than the luminance of the other region on the emitting surface 32. The luminance of the extended portion (region) 32b is also lower than the luminance of the other region on the emitting surface 32. The lower end portion 32a of the light guide component 30 consists of the extended portion (region) 32b and a region on the emitting surface 32 from which light would be reflected by the side surface and emitted if the extended portion (region) 32b were not provided.

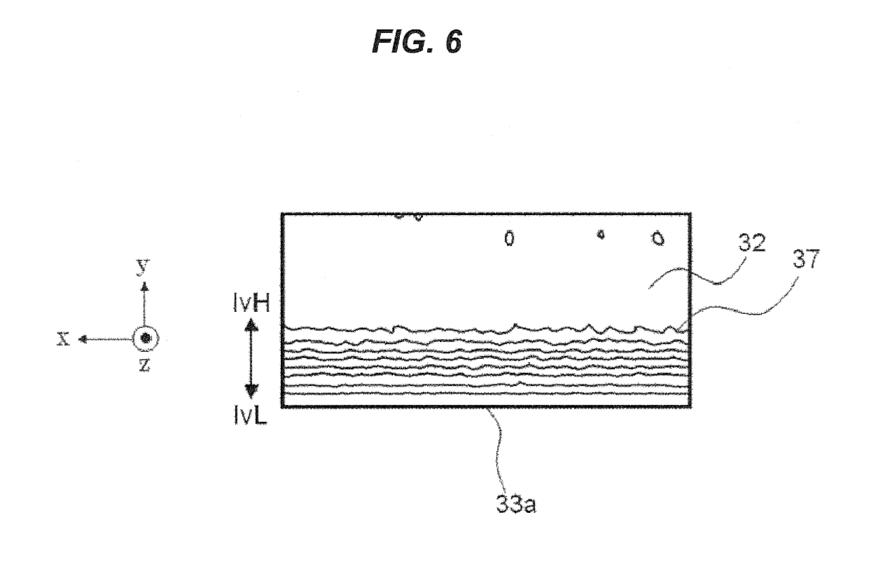

FIG. 6 is a diagram illustrating, in contour display, an example of simulation results of the luminous intensity distribution on the emitting surface 32 of the light guide component 30 in this case. The multiple lines parallel to the x axis depicted in the emitting surface 32 each represent a contour line 37 indicating the same luminous intensity. The luminous intensity on the emitting surface 32 decreases from the +y axis direction side toward the −y axis direction side. The luminous intensity IvH is higher than the luminous intensity IvL. The luminous intensity on the emitting surface 32 is lowest at the lower edge 33a. The luminous intensity on the emitting surface 32 gradually decreases from a center of the light guide component 30 in the −y axis direction.

In this manner, the light guide component 30 has the inclined surface 34 disposed so that the area of the emitting surface 32 is increased. Thus, in the light distribution pattern on the emitting surface 32, the luminous intensity gradually decreases from a center toward the edge portion of the emitting surface 32. This prevents a situation where the boundary of the light distribution pattern is emphasized and discomforts the driver. The vehicle headlight module 1 does not require a complicated optical system as required by a conventional vehicle headlight. Further, the vehicle headlight module 1 can change the illuminance distribution at the boundary of the light distribution pattern without causing reduction of the light use efficiency.

The vehicle headlight module 1 includes the light source 11, light guide component 3, and projection lens 4. The light source 11 emits light that becomes illumination light. The light guide component 3 receives the light emitted from the light source 11 as incident light through the incident surface 31, reflects the incident light by the side surfaces to superpose beams of the incident light, and emits the reflected incident light from the emitting surface 32. The projection lens 4 projects the light emitted from the emitting surface 32. The light guide component 3 has the inclined surface 33 in the side surfaces. A part of the incident light that has been reflected by the inclined surface 33 is superposed with another part of the incident light that has not been reflected by the inclined surface 33 in the partial region 32a on the emitting surface 32, so that the luminance of the partial region 32a is higher than the luminance of the other region.

That is, the luminance of the lower end portion 32a is higher than the luminance of the other region.

Also, the luminance of the lower edge 33a of the emitting surface 32 is higher than the luminance of the other region on the emitting surface 32.

The inclined surface 33 is formed by chamfering an end portion of the emitting surface 32.

The vehicle headlight module 1 includes the light source 11, light guide component 30, and projection lens 4. The light source 11 emits light that becomes illumination light. The light guide component 30 receives the light emitted from the light source 11 as incident light through the incident surface 31, reflects the incident light by the side surfaces to superpose beams of the incident light, and emits the reflected incident light from the emitting surface 32. The projection lens 4 projects the light emitted from the emitting surface 32. The light guide component 30 has the inclined surface 34 in the side surfaces. The incident light travels straight without being reflected at the position of the inclined surface 34 and exits from the partial region 32b on the emitting surface 32, so that the luminance of the partial region 32b is lower than the luminance of the other region.

The luminance of the lower end portion 32a is also lower than the luminance of the other region.

The luminance of the lower edge 33a of the emitting surface 32 is also lower than the luminance of a center of the emitting surface 32.

As described above, the lower end portion 32a of the light guide component 30 consists of the extended portion (region) 32b and the region on the emitting surface 32 from which light would be reflected by the side surface and emitted if the extended portion (region) 32b were not provided.

The inclined surface 34 is connected to an end portion of the emitting surface 32, and is inclined so as to increase the area of the emitting surface 32.

The vehicle headlight module 1 includes the light source 11, light guide component 3 or 30, and projection lens 4. The light source 11 emits light that becomes illumination light. The light guide component 3 or 30 receives the light emitted from the light source 11 as incident light through the incident surface 31, reflects the incident light by the side surfaces to superpose beams of the incident light, and emits the reflected incident light from the emitting surface 32. The projection lens 4 projects the light emitted from the emitting surface 32. The light guide component 3 or 30 has the inclined surface 33 or 34 in the side surfaces. An optical path of the incident light defined by the inclined surface 33 causes a difference in luminance between the partial region 32a or 32b and the other region on the emitting surface 32.

A difference in luminance also occurs between the lower end portion 32a and the other region on the emitting surface 32.

A difference in luminance also occurs between the lower edge 33a of the emitting surface 32 and the other region on the emitting surface 32.

The vehicle headlight module 1 further includes the light distribution control lens 2 that receives the light emitted from the light source 11. The light emitted from the light source 11 has a first divergence angle. The light distribution control lens 2 receives the light having the first divergence angle and emits light having a second divergence angle smaller than the first divergence angle.

### Second Embodiment

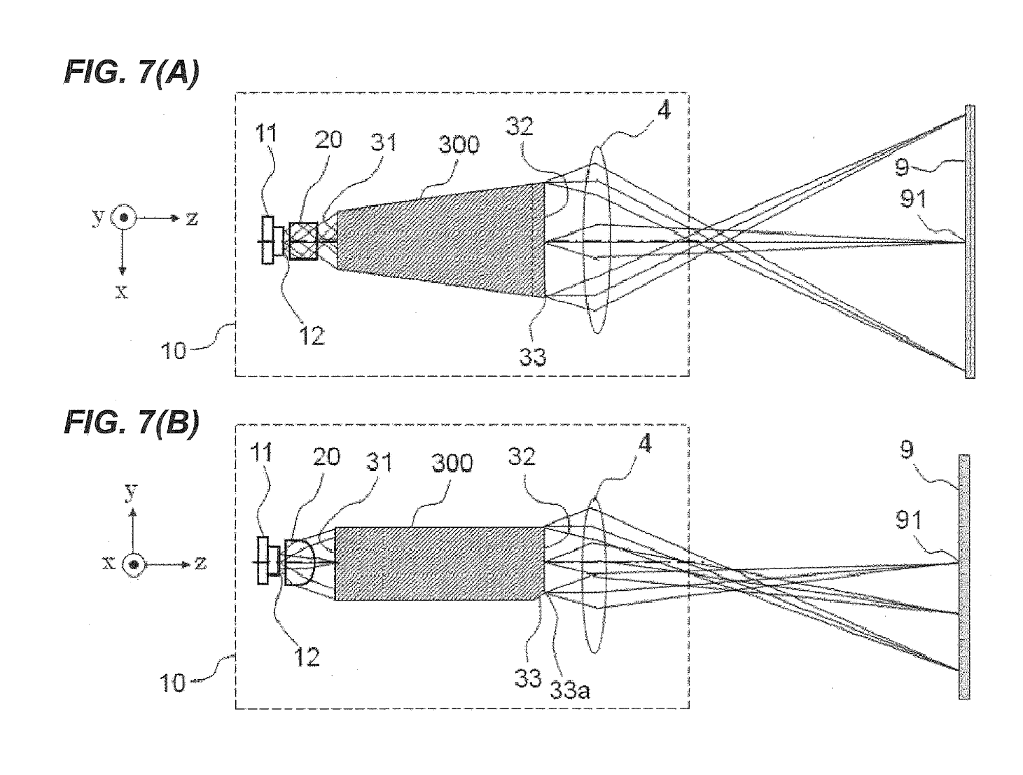

FIG. 7 is a configuration diagram illustrating a configuration of a vehicle headlight module 10 according to a second embodiment of the present invention. Elements that are the same as in FIG. 1 will be given the same reference characters, and descriptions thereof will be omitted. The elements that are the same as in FIG. 1 are the light source 11 and projection lens 4. As in the first embodiment, the light source 11 will also be referred to as the LED 11. As illustrated in FIG. 7, the vehicle headlight module 10 according to the second embodiment includes the LED 11, a light guide component 300, and the projection lens 4. The vehicle headlight module 10 may also include a light distribution control lens 20.

Unlike the first embodiment, the light distribution control lens 20 of the vehicle headlight module 10 according to the second embodiment is a cylindrical lens having curvature in only the y axis direction. “Cylindrical lens” refers to a lens at least one surface of which is formed by a cylindrical surface. “Cylindrical surface” refers to a surface having curvature in one direction but no curvature in a direction perpendicular thereto.

The light guide component 300 has a tapered shape such that the area of the emitting surface 32 is larger than the area of the incident surface 31. In FIG. 7, it has a tapered shape in the x axis direction but no tapered shape in the y axis direction. Thus, the length of the emitting surface 32 in the x axis direction is larger than the length of the incident surface 31 in the x axis direction. However, the length of the emitting surface 32 in the y axis direction is equal to the length of the incident surface 31 in the y axis direction. Side surfaces of the light guide component 300 parallel to the z-x plane have trapezoidal shapes. Side surfaces of the light guide component 300 parallel to the y-z plane have rectangular shapes. In FIG. 7, if the shapes of the emitting surface 32 and incident surface 31 are rectangular as in the first embodiment, the side surfaces opposite to each other in the y axis direction are parallel to each other. The light distribution control lens 20 may be a toroidal lens. “Toroidal lens” refers to a lens at least one surface of which is formed by a toroidal surface. “Toroidal surface” refers to a surface having different curvatures in two mutually perpendicular axis directions like the surface of a barrel or doughnut. In FIG. 7, the two mutually perpendicular axis directions are the x axis direction and y axis direction. Here, the curvature in a direction corresponding to the up-down direction (y axis direction) of a light distribution pattern 103 is larger than the curvature in a direction corresponding to the horizontal direction (x axis direction) of the light distribution pattern 103.

A light distribution pattern required for a vehicle headlight has a horizontally long shape narrow in the up-down direction. Thus, the shape of a light source employed in the vehicle headlight is desirably a horizontally long rectangular shape narrow in the up-down direction. However, if a horizontally long light source narrow in the up-down direction is employed, it is difficult to make the emission angle in the long side direction of the light source equal to or less than 50 degrees by a light distribution control lens. In order to make the emission angle in the long side direction of the light source equal to or less than 50 degrees, a large light distribution control lens is required.

Thus, the light distribution control lens 20 of the vehicle headlight module 10 has curvature with positive power in only the y axis direction, and makes the emission angle of light in the y axis direction equal to or less than 50 degrees. The light distribution control lens 20 makes the incident angle of the light incident on the light guide component 300 in the y axis direction equal to or less than 50 degrees, and thereby the emission angle of the light emitted from the emitting surface 32 can be reduced. Thus, the light distribution control lens 20 contributes to sharply forming the cutoff line 91 while reducing chromatic aberration. The light distribution control lens 20 can reduce the lens aperture of the projection lens 4 in the y axis direction. It becomes possible to reduce the lens shape of the projection lens 4 in the y axis direction. This makes it possible to improve the design of the vehicle headlight.

The light guide component 300 has a tapered shape in which the length of the emitting surface 32 in the x axis direction is larger than the length of the incident surface 31 in the x axis direction. This tapered shape can make the emission angle of the light emitted from the emitting surface 32 in the x direction smaller than the incident angle of the light incident on the incident surface 31 in the x direction.

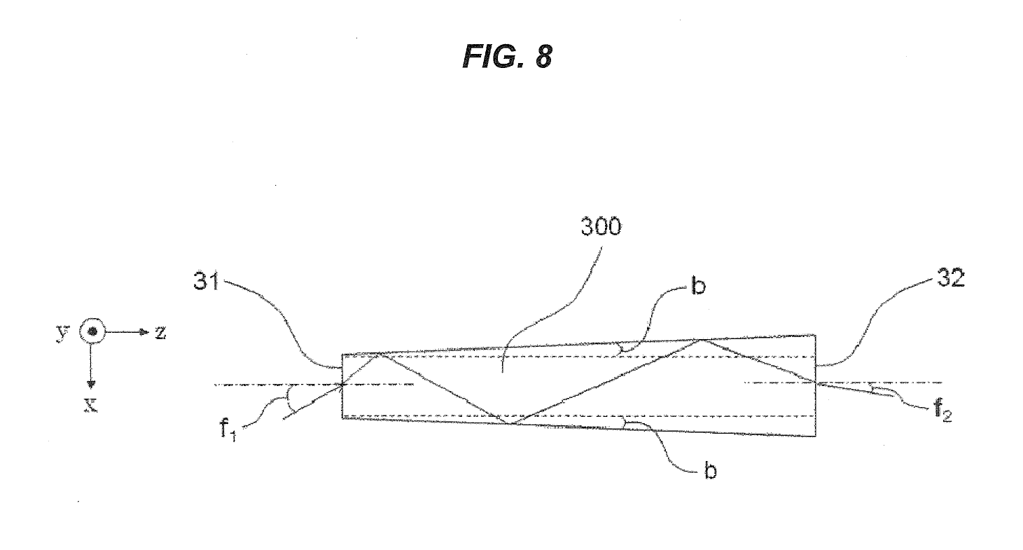

FIG. 8 is an explanatory diagram illustrating how light travels in the light guide component 300 with a tapered shape. The light guide component 300 has a tapered shape with a taper angle b. FIG. 8 is a diagram as viewed from the +y direction. As illustrated in FIG. 8, if an incident angle Dᵢₙ is f₁, an emission angle Dₒᵤₜ is f₂. In the light guide component 300, the area of the incident surface 31 is smaller than the area of the emitting surface 32. When the light guide component 300 is used, the emission angle Dₒᵤₜ of light is smaller than the incident angle Dᵢₙ. This is because, as compared to a case where the reflecting surfaces are parallel to the optical axis, each time light is reflected, the incident angle and reflection angle of the light relative to the reflecting surfaces increase by the taper angle b. In this case, if it is assumed that the incident angle on the light guide component 300 is Dᵢₙ, the taper angle of the light guide component 300 is b, the number of times the light is reflected in the tapered light guide component 300 is m, and the emission angle from the light guide component 300 is Dₒᵤₜ, the emission angle Dₒᵤₜ is given by equation (1):

Dₒᵤₜ=Dᵢₙ−2×m×b (1).

Accordingly, for example, if the incident angle in the x axis direction of light incident on the tapered light guide component 300 is 50 degrees, the emission angle in the x axis direction of the light from the emitting surface 32 is smaller than 50 degrees. Thus, the tapered light guide component 300 has the same function as the light distribution control lens 20 in terms of the control of the emission angle Dₒᵤₜ.

Thereby, the aperture of the projection lens 4 in the x axis direction can be reduced. Further, chromatic aberration occurring in the light distribution pattern on the irradiated surface 9 can be reduced considerably.

In the light guide component 300 of the vehicle headlight module 10 according to the second embodiment, the incident surface 31 and emitting surface 32 have rectangular shapes. The light guide component 300 has a tapered shape in only the x axis direction. However, these are not mandatory. The light guide component 300 may be one in which at least one of the side surfaces has a tapered shape. It may also have a tapered shape such that the area of the emitting surface 32 is larger than the area of the incident surface 31, the incident surface 31 and emitting surface 32 having arbitrary shapes. For example, it is possible that the incident surface 31 has a rectangular shape and the emitting surface 32 has a shape with the “rising line” illustrated in FIG. 4.

Further, it is only required that the emission angle of the light emitted from the emitting surface 32 can be made smaller than the incident angle of the light incident on the incident surface 31. Thus, the tapered shape of the side surfaces is not limited to straight lines, and may be arbitrary curved surfaces such as paraboloids.

It is also possible to control the emission angle of the light emitted from the emitting surface 32 to 50 degrees or less, only by the tapered shape of the light guide component 300, without using the light distribution control lens 20. Eliminating the use of the light distribution control lens 20 improves the light use efficiency of the vehicle headlight. However, typically, the optical system itself becomes larger as compared to a case where the light distribution control lens 20 is not used.

The light distribution control lens 20 is a toroidal lens. The curvature in a direction corresponding to the up-down direction (y axis direction) of the light distribution pattern of the light projected from the projection lens 4 is larger than the curvature in a direction corresponding to the horizontal direction (x axis direction) of the light distribution pattern. In the light guide component 300, the side surfaces corresponding to the left-right direction (x axis direction) of the light distribution pattern have a taper such that the area of the emitting surface 32 is larger than the area of the incident surface 31.

The light distribution control lens 20 is a cylindrical lens having a curvature in a direction corresponding to the up-down direction (y axis direction) of the light distribution pattern.

### Third Embodiment

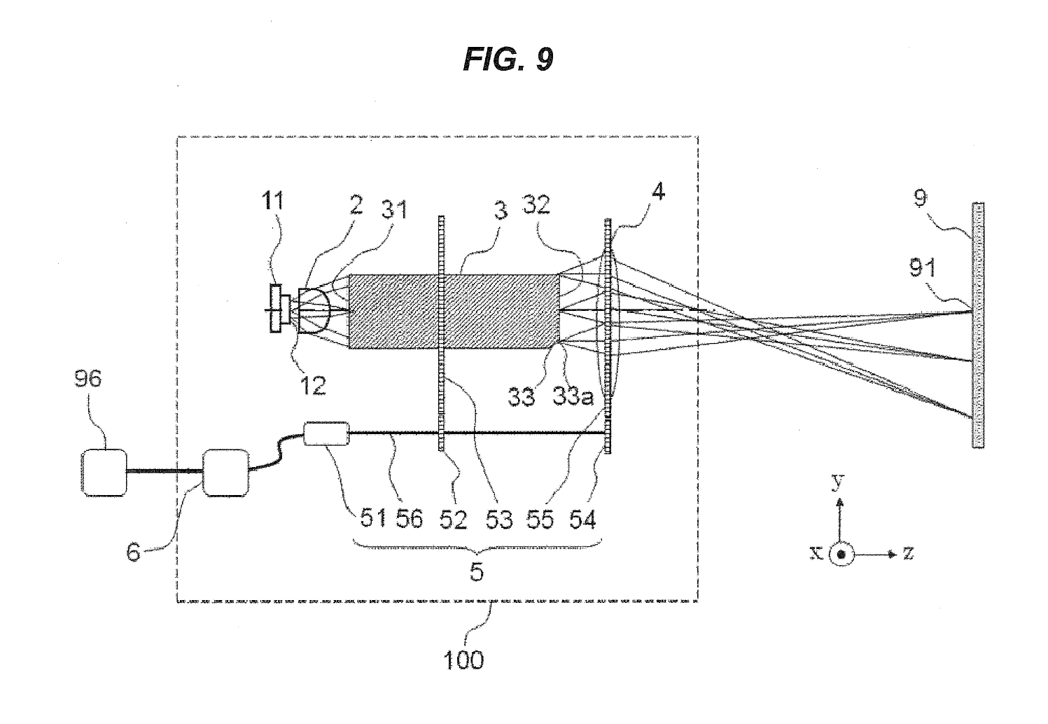

FIG. 9 is a configuration diagram illustrating a configuration of a vehicle headlight module 100 according to a third embodiment of the present invention. Elements that are the same as in FIG. 1 will be given the same reference characters, and descriptions thereof will be omitted. The elements that are the same as in FIG. 1 are the light source 11, light distribution control lens 2, light guide component 3, and projection lens 4. As in the first embodiment, the light source 11 will also be referred to as the LED 11.

As illustrated in FIG. 9, the vehicle headlight module 100 according to the third embodiment includes the light source 11, light guide component 3, projection lens 4, a rotation mechanism 5, and a control circuit 6. The rotation mechanism 5 rotates the light guide component 3 and projection lens 4 as a unit about an optical axis. “As a unit” refers to rotating simultaneously, and includes a case where a rotation angle of the light guide component 3 and a rotation angle of the projection lens 4 are different from each other. The vehicle headlight module 100 may also include the light distribution control lens 2. Thus, the vehicle headlight module 100 according to the third embodiment differs from the vehicle headlight module 1 according to the first embodiment in having the rotation mechanism 5 and control circuit 6.

In general, when a vehicle body tilts during cornering, a vehicle headlight tilts together with the vehicle body. Thus, there is a problem that a corner area toward which the driver's gaze is directed is not sufficiently illuminated. “Corner area” refers to an illumination area in the traveling direction of a vehicle when the vehicle is turning. The corner area is an area in the traveling direction toward which the driver's gaze is directed. Typically, it is an area on the left or right side of an illumination area when the vehicle travels straight.

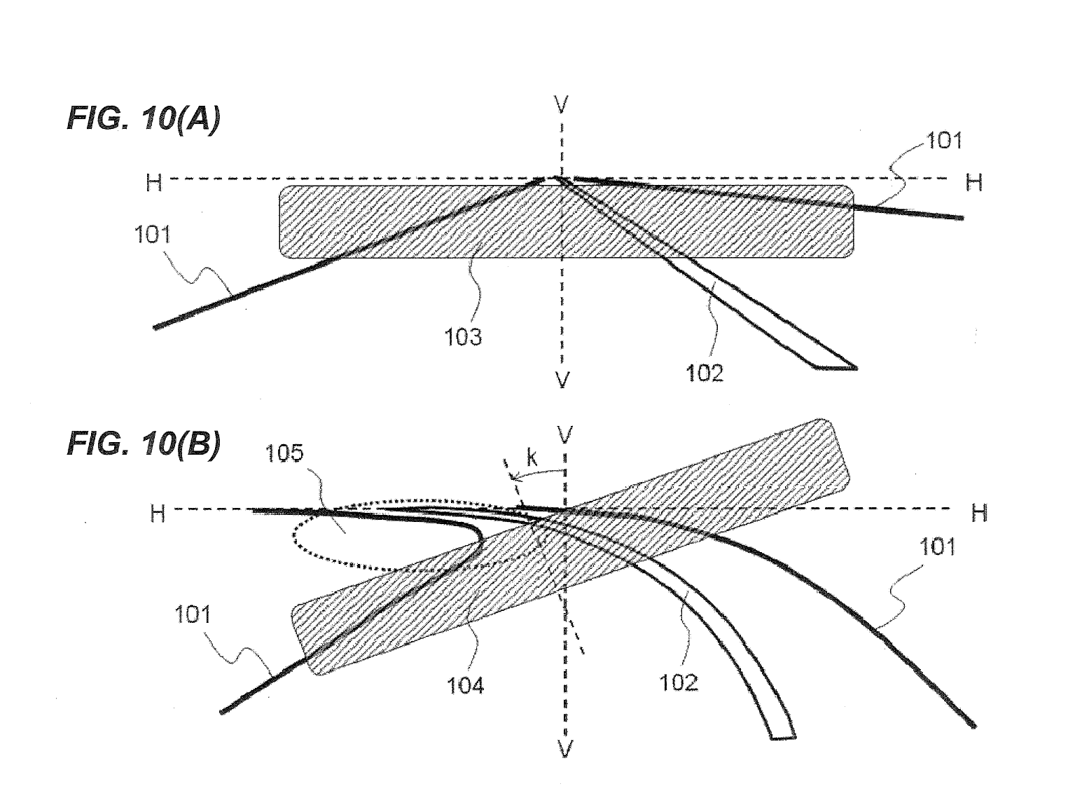

FIGS. 10(A) and 10(B) are schematic diagrams illustrating a light distribution pattern 103 of the motorcycle. FIG. 10(A) illustrates the light distribution pattern 103 in a situation where the motorcycle travels without tilting the vehicle body. FIG. 10(B) illustrates a light distribution pattern 104 in a situation where the motorcycle travels while tilting the vehicle body to the left. In FIGS. 10(A) and 10(B), the motorcycle is traveling in a left lane. The line H-H represents a horizontal line. The line V-V represents a line perpendicular to the line H-H (horizontal line) at the position of the vehicle body. Since the motorcycle travels in the left lane, the center line 102 is located on the right side of line V-V. The lines 101 represent parts of the left edge and right edge of the road surface. The motorcycle illustrated in FIG. 10(B) is cornering while tilting the vehicle body to the left by a tilt angle k with respect to the line V-V.

The light distribution pattern 103 illustrated in FIG. 10(A) is wide in the horizontal direction and illuminates a predetermined area without waste. “Predetermined” here refers to, for example, an area specified by road traffic rules or the like. However, the light distribution pattern 104 illustrated in FIG. 10(B) is radiated while being tilted in such a manner that the left side is down and the right side is up. At this time, an area in the traveling direction toward which the driver's gaze is directed is a corner area 105. When the vehicle turns left, the corner area 105 is on the front left side with respect to the traveling direction. When the vehicle turns right, the corner area 105 is on the front right side with respect to the traveling direction. Since a typical vehicle headlight is fixed to a vehicle body, it illuminates a position lower than a part on the road in the traveling direction (on the left side in FIG. 10) when the vehicle corners. Thus, the corner area 105 is not sufficiently illuminated and is dark. Further, on the side (right side in FIG. 10) opposite to the part on the road in the traveling direction, the typical vehicle headlight illuminates a position higher than the road surface. Thus, it may illuminate an oncoming vehicle with dazzling light. The tilt angle k of the vehicle body relative to the line V-V of the motorcycle is referred to as a bank angle.

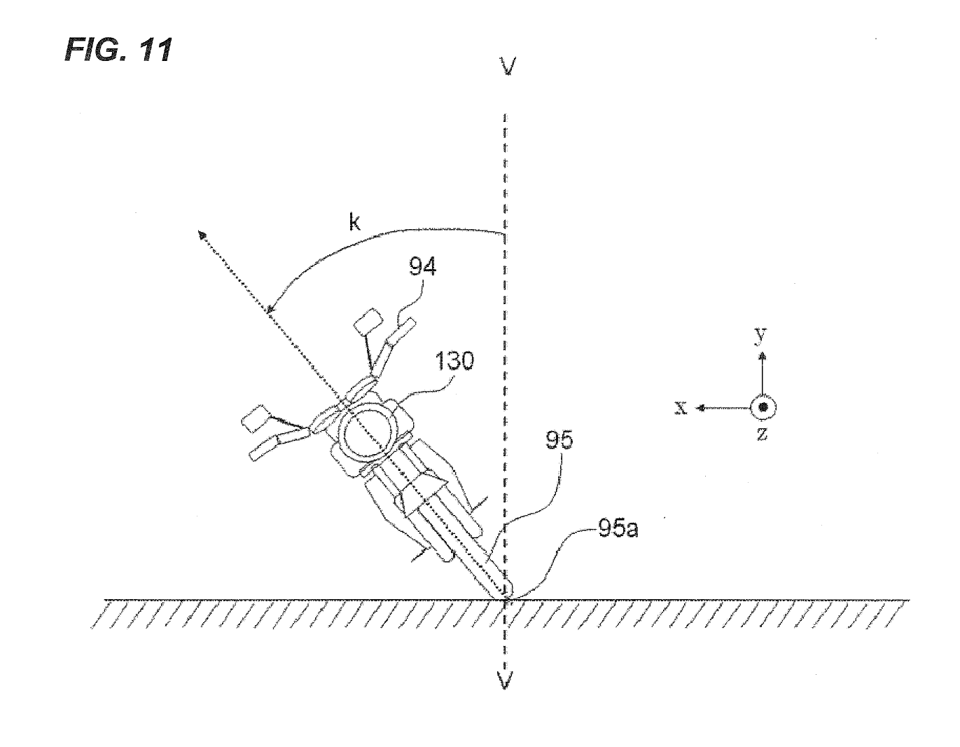

FIG. 11 is an explanatory diagram illustrating the tilt angle k of the vehicle body. In FIG. 11, the motorcycle is tilted by the tilt angle k to the right with respect to the traveling direction. In this case, it can be seen that the vehicle headlight device 130 is also tilted by the tilt angle k. Specifically, the motorcycle 94 rotates to the left or right direction about a position 95a at which a wheel 95 makes contact with the ground as a center of rotation. In FIG. 11, the motorcycle 94 is rotated counterclockwise by the angle k about the position 95a at which the wheel 95 makes contact with the ground as a center of rotation, as viewed from the +z axis direction. In this case, it can be seen that the vehicle headlight device 130 is also tilted by the tilt angle k.

The vehicle headlight module 100 according to the third embodiment solves such a problem with small and simple structure.

As illustrated in FIG. 9, the rotation mechanism 5 of the vehicle headlight module 100 according to the third embodiment supports the light guide component 3 and projection lens 4 rotatably about the optical axis as a rotational axis. The rotation mechanism 5 includes, for example, a stepping motor 51, gears 52, 53, 54, and 55, and a shaft 56.

The control circuit 6 sends a control signal to the stepping motor 51 to control a rotation angle and a rotation speed of the stepping motor 51. For the gear 53, a rotational axis of the gear 53 coincides with the optical axis of the light guide component 3. The gear 53 is mounted on the light guide component 3 so as to surround the light guide component 3. For the gear 55, a rotational axis of the gear 55 coincides with the optical axis of the projection lens 4. The gear 55 is mounted on the projection lens 4 so as to surround the projection lens 4. The shaft 56 coincides with a rotational axis of the stepping motor 51. One end of the shaft 56 is connected to a rotation shaft of the stepping motor 51. The shaft 56 is arranged in parallel with the optical axes of the light guide component 3 and projection lens 4. The gears 52 and 54 are mounted on the shaft 56. Rotational axes of the gears 52 and 54 coincide with the shaft 56. The gear 52 meshes with the gear 53. The gear 54 meshes with the gear 55.

Since the rotation mechanism 5 is configured in this manner, when the stepping motor 51 rotates, the shaft 56 rotates. As the shaft 56 rotates, the gears 52 and 54 rotate. As the gear 52 rotates, the gear 53 rotates. As the gear 54 rotates, the gear 55 rotates. As the gear 53 rotates, the light guide component 3 rotates about the optical axis. “About the optical axis” refers to rotating around the optical axis as a center. As the gear 55 rotates, the projection lens 4 rotates about the optical axis. Since the gears 52 and 54 are mounted on the single shaft 56, the light guide component 3 and projection lens 4 rotate simultaneously. Thus, the light guide component 3 and projection lens 4 rotate in conjunction with each other.

The rotation angles of the light guide component 3 and projection lens 4 depend on the numbers of teeth of the gears 52, 53, 54, and 55. If the rotation angles of the light guide component 3 and projection lens 4 are set to be equal to each other, the rotation mechanism 5 can rotate the light guide component 3 and projection lens 4 as a unit on the basis of the control signal obtained from the control circuit 6. The direction in which the light guide component 3 and projection lens 4 are rotated is a direction opposite to the tilt angle k of the vehicle body. The stepping motor 51 may be replaced with, for example, a DC motor or the like.

The emitting surface 32 of the light guide component 3 can be treated as a secondary light source. Further, the emitting surface 32 is in an optically conjugate relation with the irradiated surface 9. Thus, if the light guide component 3 and projection lens 4 are rotated about the optical axis without changing the geometrical relation between the light guide component 3 and the projection lens 4, the shape of the light distribution pattern illuminating the irradiated surface 9 is also rotated by the same rotational amount as that of the light guide component 3 and projection lens 4. Thus, by rotating the light guide component 3 and projection lens 4 in a direction opposite to the tilt angle k by the same amount as the tilt angle k, it is possible to correctly compensate the tilt of the light distribution pattern due to the tilt of the vehicle body of the motorcycle.

FIG. 11 is a schematic front view of the motorcycle 94 with its vehicle body tilted. FIG. 11 illustrates a situation where the motorcycle 94 is tilted by the tilt angle k to the right (+x axis side) with respect to the traveling direction. The control circuit 6 includes a vehicle body tilt sensor 96 for detecting the tilt angle k of the motorcycle 94. The vehicle body tilt sensor 96 is, for example, a sensor such as a gyro. The control circuit 6 receives a signal of the tilt angle k of the vehicle body detected by the vehicle body tilt sensor 96, and performs calculation based on the detected signal to control the stepping motor 51. If the tilt angle of the motorcycle 94 is k, the control circuit 6 rotates the light guide component 3 and projection lens 4 by the angle k in a direction opposite to the tilt direction of the vehicle body.

The configuration of the rotation mechanism 5 is not limited to the above configuration and may be another rotation mechanism. It is possible to provide stepping motors for rotating each of the light guide component 3 and projection lens 4, and control their rotational amount separately. If the projection lens 4 has a rotationally symmetrical shape with respect to the optical axis, it is possible to rotate only the light guide component 3 without rotating the projection lens 4. On the other hand, if the projection lens 4 is a “toroidal lens” or the like as described above, it is necessary to rotate the light guide component 3 and projection lens 4.

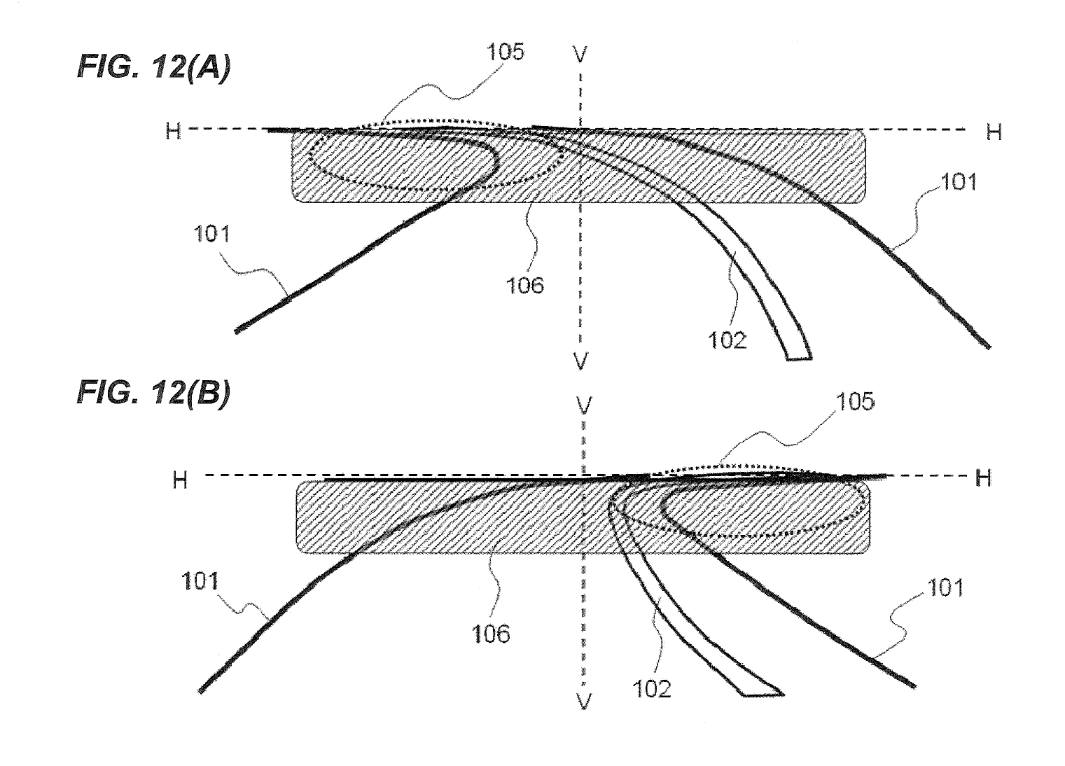

FIGS. 12(A) and 12(B) are schematic diagrams each illustrating a case where the light distribution pattern is corrected by the vehicle headlight module 100. FIG. 12(A) illustrates a case of cornering to the left while traveling in the left lane. FIG. 12(B) illustrates a case of cornering to the right while traveling in the left lane. As described above, the control circuit 6 rotates the light distribution pattern 106 in accordance with the tilt angle k of the vehicle body. The light distribution pattern 106 in FIG. 12(A) is rotated by the tilt angle k clockwise as viewed in the traveling direction. The light distribution pattern 106 in FIG. 12(B) is rotated by the tilt angle k counterclockwise as viewed in the traveling direction. Whether the vehicle body tilts to the left or right, the vehicle headlight module 100 can achieve the same light distribution pattern 106 as in the case where the vehicle body is not tilted, as a result.

In this manner, the vehicle headlight module 100 according to the third embodiment rotates the light guide component 3 and projection lens 4 in accordance with the tilt angle k of the vehicle body. Thereby, the formed light distribution pattern 106 rotates about the optical axis of the optical system as a rotational axis. The projection lens 4 magnifies and projects light with the rotated light distribution pattern 106. Thereby, the vehicle headlight module 100 can illuminate an area (corner area 105) in the traveling direction toward which the driver's gaze is directed. Further, since the light guide component 3 and projection lens 4 to be rotated are relatively small, it is possible to drive them with a small driving force, as compared to a case of rotating a light source (lamp light source) and a large-diameter lens or reflecting mirror (reflector) that are provided in a conventional vehicle headlight. “Relatively” here refers to comparison with a conventional light source (lamp light source) and a large lens or reflecting mirror (reflector). Further, it becomes unnecessary to rotatably support a large-diameter lens or reflecting mirror (reflector) or the like. From these, the rotation mechanism can be downsized.

The vehicle headlight module 100 according to the third embodiment rotates the light guide component 3 and projection lens 4 of the vehicle headlight module 1 according to the first embodiment about the optical axis. However, the same advantages are obtained even if the light guide component 3 and projection lens 4 of the vehicle headlight module 10 according to the second embodiment are rotated about the optical axis.

Further, in a case where a lens surface of the projection lens 4 has a rotationally symmetrical shape and a center of curvature of the projection lens 4 coincides with the optical axis of the light guide component 3, the same advantages are obtained by rotating only the light guide component 3 about the optical axis without rotating the projection lens 4. In this case, the optical axis of the projection lens 4 coincides with the optical axis of the light guide component 3. In this case, the rotation mechanism can be downsized and simplified, as compared to a case where the light guide component 3 and projection lens 4 are integrally rotated about the optical axis.

On the other hand, in a case where the optical axis of the projection lens 4 is located on the lower side (−y axis direction) of the optical axis of the light guide component 3 as described in the first embodiment, the light guide component 3 and projection lens 4 are rotated about a common rotational axis without changing the positional relationship between the light guide component 3 and the projection lens 4. In this case, it is necessary that the rotational axis of the light guide component 3 or the rotational axis of the projection lens 4 is displaced from an optical axis.

The rotational axis of the light guide component 3 may be an axis other than an optical axis. For example, the light guide component 3 may be rotated about a straight line passing through the incident surface 31 and emitting surface 32 as a rotational axis. In this case, it is difficult to form the light distribution pattern 103. However, the light guide component 3 may be inclined with respect to an optical axis to the extent that it does not cause a major problem in forming the light distribution pattern 103, from design constraints. Further, if the rotational axis is inclined with respect to the light guide component 3, the rotational axis does not pass through a center of the light guide component 3. Thus, the light guide component 3 rotates about an eccentric axis. This increases the space required for rotation of the light guide component 3 and enlarges the device.

Further, the rotational axis of the light guide component 3 may be a straight line that passes through the incident surface 31 and is parallel to the optical axis of the light guide component 3. In this case, it is possible to prevent the light distribution pattern 103 from moving in the x or y axis direction on the irradiated surface 9. However, even in this case, if the rotational axis passes through a position displaced from a center of the incident surface 31, the incident surface 31 needs to be large to receive light.

Thus, the rotational axis may be set to pass through the center of the incident surface 31. This reduces the space required for rotation of the light guide component 3, allowing the device to be downsized. Further, this rotational axis may coincide with a center of the light beam incident on the incident surface 31. In this case, the incident surface 31 of the light guide component 3 can be minimized. Thus, the light guide component 3 can be minimized.

The vehicle headlight module 100 according to the third embodiment rotates, in accordance with the tilt angle k, the light guide component 3 and projection lens 4 about the optical axis by the angle k in a direction opposite to the tilt angle. However, this is not mandatory. For example, the light guide component 3 and projection lens 4 may be rotated about the optical axis by an angle larger than the tilt angle k. As such, the rotation angle may be set to an arbitrary angle. Thus, the light distribution pattern can be intentionally tilted as necessary, instead of being always horizontal. For example, by tilting the light distribution pattern so as to raise the corner area 105 side of the light distribution pattern, it is possible to make it easy for the driver to observe an area in the traveling direction of the vehicle. In the case of a left hand corner, by tilting the light distribution pattern so as to lower a side of the light distribution pattern opposite to the corner area 105, it is possible to reduce dazzling of an oncoming vehicle due to projection light.

The third embodiment rotates the light guide component 3 or projection lens 4 about an axis parallel to the optical axis as a rotational axis in accordance with the tilt of the vehicle. However, even when the vehicle is not tilted, if the optimum visibility or optimum illumination can be obtained by tilting the light distribution pattern 103, the light guide component 3 or projection lens 4 may be rotated about an axis parallel to the optical axis as a rotational axis. For example, when there is an uphill on the left side with respect to the traveling direction, even if the vehicle body is not tilted, it is possible to rotate the light distribution pattern 103 clockwise as viewed in the traveling direction to ensure the visibility of the uphill portion. When there are many oncoming vehicles, even if the vehicle body is not tilted, it is possible to rotate the light distribution pattern 103 to lower the light distribution pattern on the oncoming vehicle side, thereby reducing dazzling.

Although the embodiment describes a motorcycle as described above, it is not limited to the motorcycle. For example, the vehicle headlight module may be employed in a motor tricycle. It is, for example, a motor tricycle called a gyro. “Motor tricycle called a gyro” refers to a scooter with three wheels including one front wheel and two rear wheels about one axis. In Japan, it corresponds to a motorbike. It has a rotational axis near a center of the vehicle body and allows most of the vehicle body including the front wheel and driver seat to be tilted in the left-right direction. This mechanism allows the center of gravity to move inward during turning similarly to a motorcycle. The vehicle headlight module may also be employed in a four-wheeled automobile. In the case of a four-wheeled automobile, for example, when it corners to the left, the vehicle body tilts to the right. When it corners to the right, the vehicle body tilts to the left. This is due to centrifugal force. In this respect, it is opposite in the bank direction to a motorcycle. However, a four-wheeled automobile may also detect the bank angle of the vehicle body to correct the light distribution pattern 103. In a four-wheeled automobile having the vehicle headlight device according to the present invention, when the vehicle body tilts because, for example, only a wheel or wheels on one side drive over an obstacle or the like, it is possible to obtain the same light distribution pattern 103 as when the vehicle body is not tilted.

The vehicle headlight module 100 rotates the light guide component 3 about an axis parallel to the optical axis as a rotational axis.

The vehicle headlight module 100 rotates the projection lens 4 about an axis parallel to the optical axis as a rotational axis.

### Fourth Embodiment

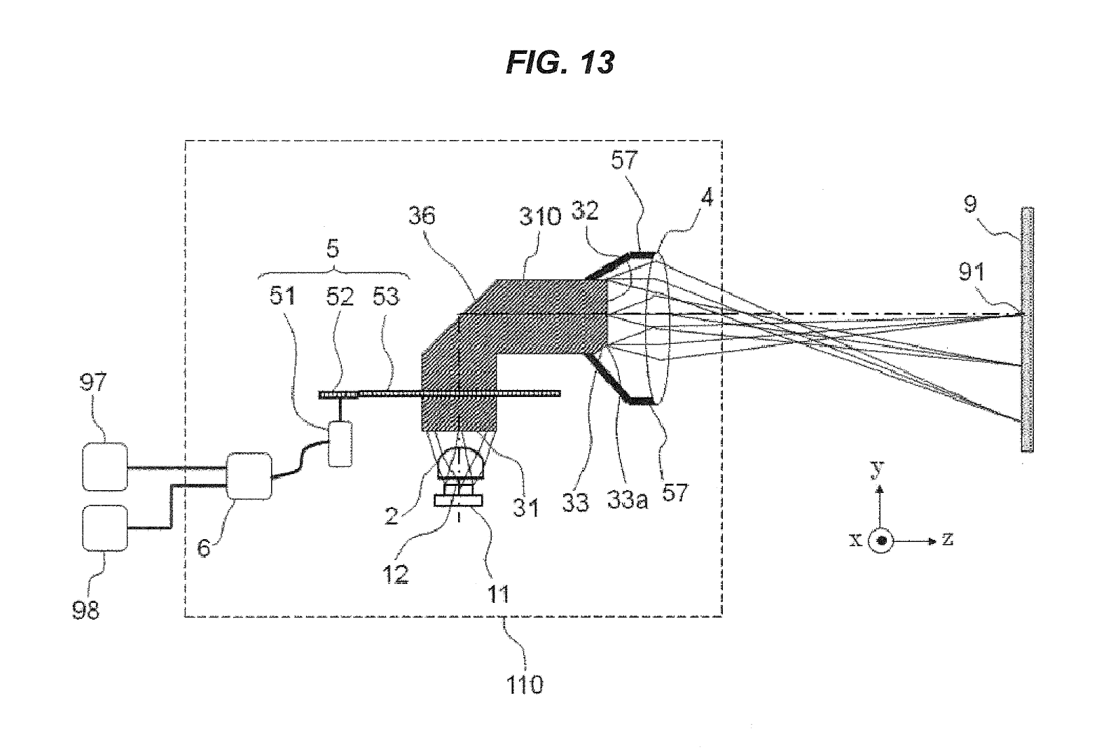

FIG. 13 is a configuration diagram illustrating a configuration of a vehicle headlight module 110 according to a fourth embodiment of the present invention. Elements that are the same as in FIG. 1 will be given the same reference characters, and descriptions thereof will be omitted. The elements that are the same as in FIG. 1 are the light source 11, light distribution control lens 2, and projection lens 4. As in the first embodiment, the light source 11 will also be referred to as the LED 11.

As illustrated in FIG. 13, the vehicle headlight module 110 according to the third embodiment includes the LED 11, a light guide component 310, the projection lens 4, a rotation mechanism 5, and a control circuit 6. The rotation mechanism 5 rotates the light guide component 310 and projection lens 4 as a unit about an optical axis. “Optical axis” here is an optical axis on the incident surface 31 of the light guide component 310. Unlike the first to third embodiments, the light guide component 310 of the fourth embodiment is bent by 90 degrees at a position of a reflecting surface 36. Thus, even if the light guide component 310 is rotated about the optical axis on the incident surface 31, it does not rotate about an optical axis on the emitting surface 32. The vehicle headlight module 110 may include the light distribution control lens 2. The vehicle headlight module 110 according to the fourth embodiment differs from the vehicle headlight module 1 according to the first embodiment in having the rotation mechanism 5 and control circuit 6. The light guide component 310 differs in that it has the reflecting surface 36, reflects light emitted from the LED 11 at 90 degrees at the reflecting surface 36, and guides the light to the projection lens 4.

In vehicle headlights, a technique is known in which, when a vehicle corners, the optical axis of its vehicle headlight is controlled to be directed in the traveling direction. In particular, in vehicle headlights for automobiles, an illuminating direction of a vehicle headlight is moved in the left-right direction (x direction) of the vehicle on the basis of information on a steering angle of the automobile, a vehicle speed, a vehicle height, or the like. “Steering angle” refers to an angle of steering for arbitrarily changing the traveling direction of the vehicle. However, a conventional vehicle headlight typically employs a method of turning the entire vehicle headlight. Thus, there is a problem that the drive unit is large. There is also a problem that the load of the drive unit is large.

The vehicle headlight module 110 according to the fourth embodiment of the present invention solves these problems and has a small and simple configuration.

The LED 11 is disposed so that the light emitting surface 12 faces upward (+y axis direction). Thus, an optical axis of the LED 11 is parallel to the y axis.

The light guide component 310 has, in its light guiding path, the reflecting surface 36. Similarly to the above-described light guide components 3, 30, and 300, the light guide component 310 reflects light therein to guide the light from the incident surface 31 to the emitting surface 32, forming the light guiding path. The reflecting surface 36 bends, by 90 degrees, light entering through the incident surface 31 in the +y axis direction. In FIG. 13, the light whose traveling direction has been bent by 90 degrees at the reflecting surface 36 travels ahead of the vehicle (in the +z axis direction). The incident surface 31 is a surface parallel to the z-x plane. The emitting surface 32 is a surface parallel to the x-y plane. The reflecting surface 36 may be a surface using total reflection. The reflecting surface 36 may also be a surface using a mirror surface. “Mirror surface” refers to, for example, a surface obtained by evaporating aluminum onto a reflecting surface. The reflecting surface using total reflection can provide higher light use efficiency. The optical axis on the emitting surface 32 is bent by 90 degrees from the optical axis of the LED 11 by the reflecting surface 36. Thus, the optical axis on the emitting surface 32 is directed ahead of the vehicle (in the +z axis direction). Thus, a desired light distribution pattern can be formed by the same projection lens 4 as in the first, second, and third embodiments of the present invention. If the light guide component 310 is rotated about the optical axis on the incident surface 31, the optical axis on the emitting surface 32 becomes non-parallel to the z axis. The optical axis on the emitting surface 32 is tilted with respect to the z axis on the z-x plane by the angle by which the light guide component 310 is rotated.

As illustrated in FIG. 13, the rotation mechanism 5 supports the light guide component 310 and projection lens 4 rotatably about the optical axis on the incident surface 31 of the LED 11 as a rotational axis. The projection lens 4 is mounted on the light guide component 310 by a support part 57. The rotation mechanism 5 includes, for example, a stepping motor 51, and gears 52 and 53. The control circuit 6 sends a control signal to the stepping motor 51 to control a rotation angle and a rotation speed of the stepping motor 51. For the gear 53, a rotational axis of the gear 53 coincides with the optical axis on the incident surface 31 of the light guide component 310. The gear 53 is mounted on the light guide component 3 so as to surround a part on the −y axis direction side of the reflecting surface 36 of the light guide component 3. The gear 52 is mounted on a rotation shaft of the stepping motor 51. The gear 52 meshes with the gear 53. Since the rotation mechanism 5 is configured in this manner, when the stepping motor 51 rotates, the gear 52 rotates. As the gear 52 rotates, the gear 53 rotates. As the gear 53 rotates, the light guide component 310 rotates about the optical axis on the incident surface 31. Since the projection lens 4 is mounted on the light guide component 310 by the support part 57, it rotates together with the light guide component 310. The rotation mechanism 5 can rotate the light guide component 3 and projection lens 4 as a unit on the basis of the control signal obtained from the control circuit 6.

The emitting surface 32 of the light guide component 310 can be treated as a secondary light source. Further, the emitting surface 32 is in an optically conjugate relation with the irradiated surface 9. Thus, by rotating the light guide component 310 and projection lens 4 about the optical axis of the LED 11 by using the rotation mechanism 5 without changing the geometrical relation between the light guide component 310 and the projection lens 4, the vehicle headlight module 110 can turn, in the horizontal direction (x axis direction), the optical axis of light irradiating the irradiated surface 9. In FIG. 13, rotation about the optical axis of the LED 11 is equivalent to rotation about the optical axis on the incident surface 31.

The control circuit 6 calculates the traveling direction of the vehicle on the basis of, for example, signals detected by a steering angle sensor 97, a vehicle speed sensor 98, and the like. The control circuit 6 then controls the stepping motor 51 so that the optical axis on the emitting surface 32 of the vehicle headlight module 110 is directed in an optimum direction. “Steering angle sensor” refers to a sensor for sensing a steering angle of the front wheel or wheels when a steering wheel is turned.

The rotation mechanism 5 has a function of rotating the light guide component 3 and projection lens 4 with an axis parallel to the optical axis of the LED 11 as a rotational axis. In FIG. 13, the axis parallel to the optical axis of the LED 11 is the axis of the stepping motor 51. Thus, the configuration of the rotation mechanism 5 is not limited to the above-described configuration. For example, another gear may be disposed between the gear 52 mounted on the stepping motor 51 and the gear 53.

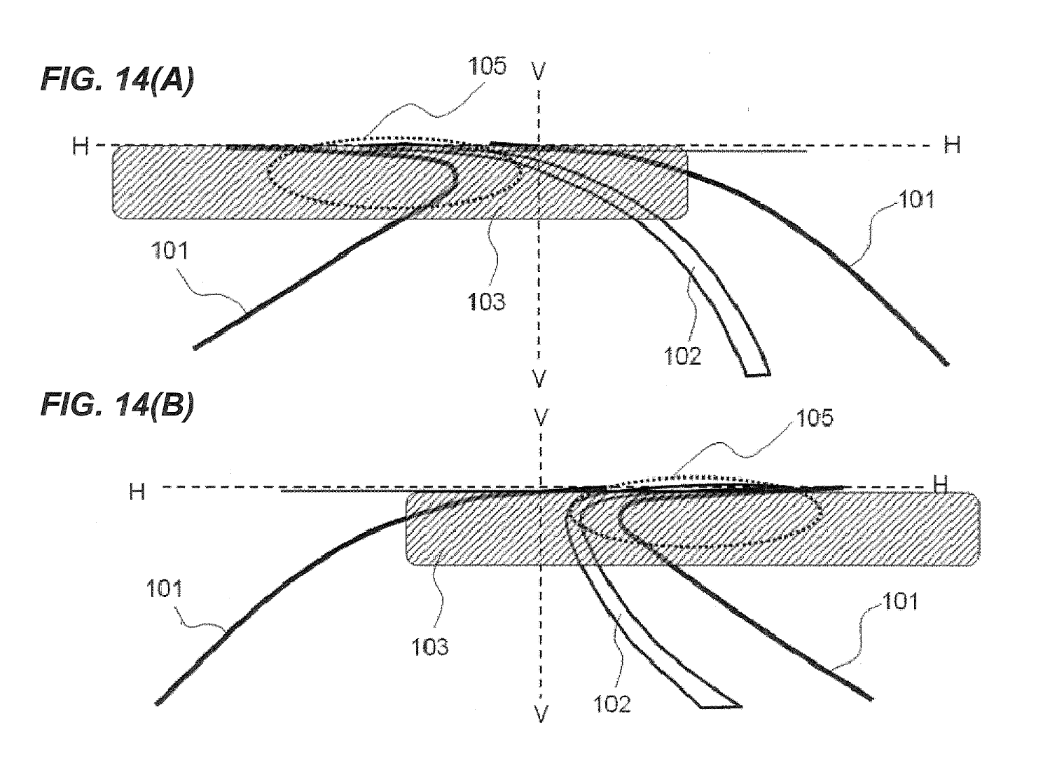

FIGS. 14(A) and 14(B) are diagrams each illustrating an irradiated area when a vehicle with the vehicle headlight module 110 according to the fourth embodiment is cornering. FIG. 14(A) illustrates a situation where the vehicle is traveling in the left lane of a corner curving to the left. FIG. 14(B) illustrates a situation where the vehicle is traveling in the left lane of a corner curving to the right. As described above, the control circuit 6 can direct the light distribution pattern 103 in an optimum direction by turning the optical axis of the light distribution pattern 103 in the horizontal direction in accordance with the steering angle of the vehicle or the like. Thus, whether the vehicle travels in a curve to the left or right, the control circuit 6 can direct the optical axis (a center of the light distribution pattern 103 in the horizontal direction) toward the corner area 105 toward which the driver's gaze is directed. That is, whether the vehicle travels in a curve to the left or right, the control circuit 6 can direct the light distribution pattern 103 toward the corner area 105 toward which the driver's gaze is directed. By the control of the control circuit 6, the vehicle headlight module 110 can illuminate the corner area 105 with a part of the light distribution pattern 103 where the illuminance is highest.

In this manner, the vehicle headlight module 110 according to the fourth embodiment rotates the light guide component 3 and projection lens 4 as a unit about the optical axis of the LED 11 as a rotational axis by an optimum angle corresponding to the steering angle of the vehicle or the like. Thereby, when the vehicle turns a corner to the right or left, the vehicle headlight module 110 can illuminate an area (the corner area 105) toward which the driver's gaze is directed, with a part of the light distribution pattern 103 where the illuminance is highest. The vehicle headlight module 110 rotates the light guide component 3 and projection lens 4. Thus, the vehicle headlight module 110 can drive the driven part (light guide component 3 and projection lens 4) with a small driving force, as compared to a conventional case of rotating an illuminator (lamp light source) and a large-diameter lens or reflecting mirror (reflector) that are provided in a lamp main body. Further, since the driven part (light guide component 3 and projection lens 4) is smaller than that of the conventional case, the structure for supporting the driven part can be made small.

The vehicle headlight module 110 according to the fourth embodiment uses the light guide component 310 in which the incident surface 31 and emitting surface 32 have the same area, like the light guide component 3 of the first embodiment. However, the vehicle headlight module 110 may use a light guide component in which the area of the emitting surface 32 is larger than that of the incident surface 31, like the light guide component 300 of the second embodiment. Thus, the light guide component 310 may have a shape with a taper angle b.

In the vehicle headlight module 110 according to the fourth embodiment, the reflecting surface 36, which bends the optical axis by 90 degrees, is provided in the light guiding path of the light guide component 310. However, it is not necessary that the number of reflecting surfaces in the light guiding path is one, and it may have multiple reflecting mirrors as long as the emitting surface 32 is directed ahead of the vehicle.

The following two methods may be used to move the light distribution pattern right and left with respect to the traveling direction of the vehicle as in the fourth embodiment.

The first method is a method of moving the projection lens 4 of the vehicle headlight module 1 of the first embodiment in the left-right direction (x axis direction). When the optical axis of the projection lens 4 is moved in the +x axis direction relative to the optical axis of the light guide component 3, the light distribution pattern on the irradiated surface 9 moves right (in the +x axis direction). On the contrary, when the optical axis of the projection lens 4 is moved in the −x axis direction relative to the optical axis of the light guide component 3, the light distribution pattern on the irradiated surface 9 moves left (in the −x axis direction).

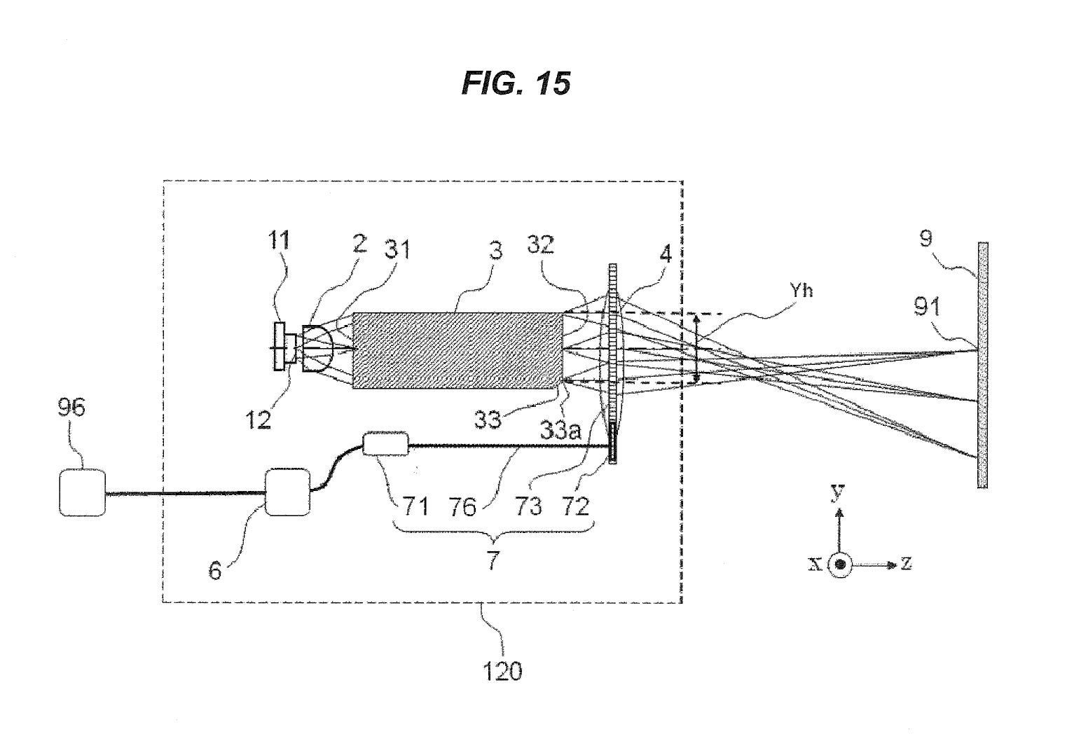

The first method can be implemented by, for example, a configuration obtained by changing the configuration illustrated in FIG. 15 of a fifth embodiment so that the projection lens 4 moves in the x axis direction. The configuration illustrated in FIG. 15 of the fifth embodiment moves the projection lens 4 in the y axis direction relative to the light guide component 3. The first method is, for example, one obtained by rotating the configuration illustrated in FIG. 15 by 90 degrees about an optical axis (axis parallel to the z axis).

The second method is a method of tilting the projection lens 4 of the vehicle headlight module 1 of the first embodiment in the left-right direction. Thus, it is a method of rotating the projection lens 4 about an axis that is parallel to the y axis and passes through the optical axis, as a rotational axis. When the projection lens 4 is rotated about the rotational axis clockwise as viewed from the +y axis direction, the light distribution pattern on the irradiated surface 9 moves to the right (in the +x axis direction). On the contrary, when the projection lens 4 is rotated about the rotational axis counterclockwise, the light distribution pattern on the irradiated surface 9 moves to the left (in the −x axis direction).

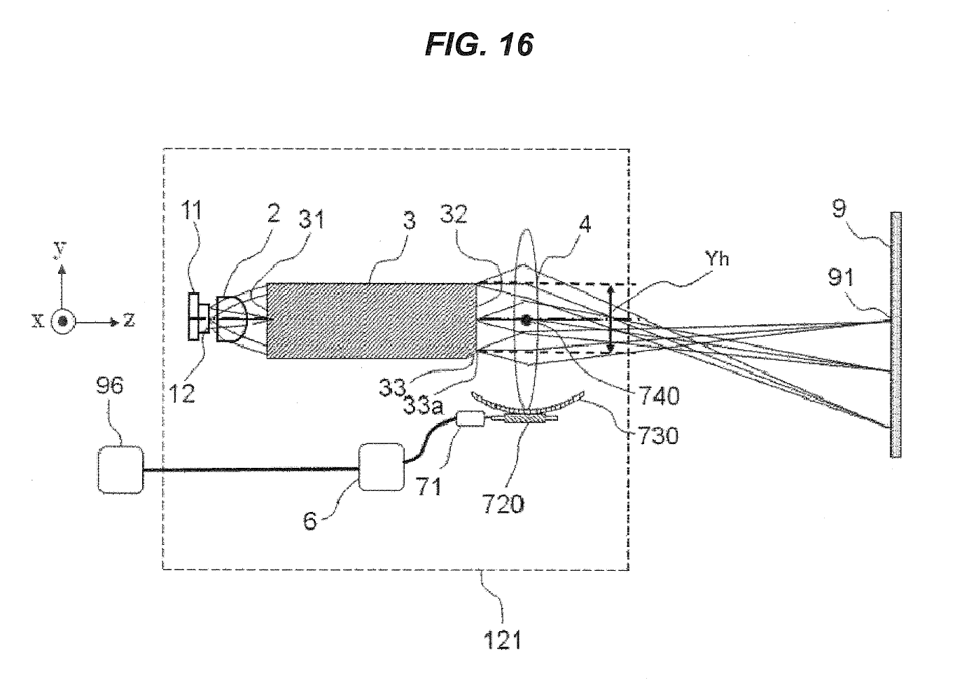

The second method can be implemented by, for example, a configuration obtained by changing the configuration illustrated in FIG. 16 of the fifth embodiment so that the projection lens 4 rotates about the y axis. The configuration illustrated in FIG. 16 of the fifth embodiment rotates the projection lens 4 about the x axis. The second method is, for example, one obtained by rotating the configuration illustrated in FIG. 16 by 90 degrees about an optical axis (axis parallel to the z axis).

The above-described two methods have been described using the vehicle headlight module 1 of the first embodiment as an example, but they may also be applied to the optical systems of the other vehicle headlight modules 10, 100, and 110. The above-described two methods make it possible to easily move the light distribution pattern on the irradiated surface 9 in the left-right direction as viewed in the traveling direction. This is because, in the first method, the part to be moved is only the projection lens 4, and the movement can be performed with a small driving force as compared to the vehicle headlight module 110. Also, in the second method, the part to be moved is only the projection lens 4, and the movement can be performed with a small driving force as compared to the vehicle headlight module 110. Further, rotating a part can be smoothly performed with a small driving force, as compared to translating the part. Thus, the second method can smoothly perform the movement with a small driving force, as compared to the first method.

Further, the fourth embodiment takes, as an example, a case where the vehicle turns a curve. However, it is also possible, for example, when the vehicle turns right or left at an intersection or the like, to move the light distribution pattern on the irradiated surface 9 in the left-right direction as viewed in the traveling direction. In the case of vehicle headlight devices each having multiple vehicle headlight modules as described later, for example, in turning right, it is possible to move only the rightmost vehicle headlight module in a right-hand vehicle headlight device to move the light distribution pattern on the irradiated surface 9 to the right as viewed in the traveling direction. Also, in turning to left, it is possible to move only the leftmost vehicle headlight module in a left-hand vehicle headlight device to move the light distribution pattern on the irradiated surface 9 to the left as viewed in the traveling direction.

The light guide component 310 has, between the incident surface 31 and the emitting surface 32, the reflecting surface 36 that bends the traveling direction of light ahead of the vehicle. The vehicle headlight module 110 rotates the light guide component 310 and projection lens 4 about the optical axis on the incident surface 31 as a rotational axis.

### Fifth Embodiment

FIG. 15 is a configuration diagram illustrating a configuration of a vehicle headlight module 120 according to the fifth embodiment of the present invention. Elements that are the same as in FIG. 1 will be given the same reference characters, and descriptions thereof will be omitted. The elements that are the same as in FIG. 1 are the light source 11, light distribution control lens 2, light guide component 3, and projection lens 4. As in the first embodiment, the light source 11 will also be referred to as the LED 11. As illustrated in FIG. 15, the vehicle headlight module 120 according to the fifth embodiment includes the light source 11, the light guide component 3, the projection lens 4, a translation mechanism 7, and a control circuit 6. The translation mechanism 7 moves the projection lens 4 in the y axis direction. The vehicle headlight module 120 may also include the light distribution control lens 2. Thus, the vehicle headlight module 120 differs from the vehicle headlight module 1 of the first embodiment in having the translation mechanism 7 and control circuit 6.

For example, in a vehicle headlight of an automobile, when people, luggage, or the like is loaded on the rear part of the vehicle, the vehicle body tilts backward. Also when the vehicle accelerates, the vehicle body tilts backward. On the contrary, when the vehicle decelerates, the vehicle body tilts forward. When the vehicle body tilts forward and backward in this manner, the optical axis of the light distribution pattern of the vehicle headlight also shifts in the up-down direction. That is, when the vehicle body tilts forward and backward, the light distribution pattern moves up and down. Thus, the vehicle cannot obtain the optimum light distribution. Further, upward movement of the light distribution pattern causes a problem, such as dazzling an oncoming vehicle. As a method for reducing the change of the light distribution due to the tilt of the vehicle body in the front-back direction, a method of tilting the entire vehicle headlight in a direction opposite to the tilt of the vehicle body is commonly used. However, since the conventional technique tilts the vehicle headlight, it has a problem that the driving mechanism is large.

The vehicle headlight module 120 according to the fifth embodiment solves such a problem easily with a small and simple configuration.

As illustrated in FIG. 15, the translation mechanism 7 includes a stepping motor 71, a pinion 72, a rack 73, and a shaft 76. A shaft of the stepping motor 71 is connected to the shaft 76. The shaft of the stepping motor 71 and the shaft 76 are disposed in parallel with the z axis. That is, the shaft of the stepping motor 71 and the shaft 76 are disposed in parallel with the optical axis of the projection lens 4. The pinion 72 is mounted on the shaft 76.

An axis of the pinion 72 is parallel to the z axis. Teeth of the pinion 72 meshes with teeth of the rack 73. The rack 73 is disposed on the right side of the projection lens 4, as viewed in a direction (+z axis direction) from the vehicle headlight module 120 to the irradiated surface 9. Unlike FIG. 15, the rack 73 may be disposed on the left side of the projection lens 4, as viewed in a direction (+z axis direction) from the vehicle headlight module 120 to the irradiated surface 9. The rack 73 is mounted on the projection lens 4. The rack 73 is disposed in parallel with the y axis. Thus, the rack 73 is disposed so that the teeth of the rack 73 are aligned in the vertical direction (y axis direction). The teeth of the rack 73 are formed on the outer side with respect to the projection lens 4. The pinion 72 is disposed on the outer side of the rack 73 with respect to the projection lens 4. Specifically, if the rack 73 is disposed in the +x axis direction from the projection lens 4, the pinion 72 is disposed in the +x axis direction from the rack 73. If the rack 73 is disposed in the −x axis direction from the projection lens 4, the pinion 72 is disposed in the −x axis direction from the rack 73.

The pinion 72 rotates about an axis of the pinion 72 by rotation of the shaft 76. As the pinion 72 rotates, the rack 73 moves in the y axis direction. As the rack 73 moves in the y axis direction, the projection lens 4 moves in the y axis direction.

The translation mechanism 7 of the vehicle headlight module 120 according to the fifth embodiment supports the projection lens 4 so that the projection lens 4 can be translated in the y axis direction, as illustrated in FIG. 15. The translation mechanism 7 includes, for example, the stepping motor 71, pinion 72, rack 73, and shaft 76. The translation mechanism 7 translates the projection lens 4 in the up-down direction on the basis of the amount of tilt of the vehicle body obtained from the control circuit 6. “Translation” refers to parallel displacement of each point constituting a rigid body or the like in the same direction.

For example, the control circuit 6 receives a signal of an angle of tilt of the vehicle body in the front-back direction detected by a vehicle body tilt sensor 96. The vehicle body tilt sensor 96 detects the tilt of the vehicle body in the front-back direction. The control circuit 6 then performs calculation on the basis of the signal of the tilt angle to control the stepping motor 71. The tilt sensor is, for example, a sensor such as a gyro.

For example, it is assumed that the height in the y direction of the emitting surface 32 of the light guide component 3 is 4.0 mm; the projection lens 4 is a lens that images the emitting surface 32 at a magnification of 1250 onto an irradiated surface 25 m ahead. If it is assumed that the vehicle body tilts by 5 degrees in the front-back direction in such a manner that the front side moves upward, displacement of the optical axis at 25 m ahead is represented by the following equation (2):

25000 mm×tan 5°=2187.2 mm (2).

Specifically, the optical axis is displaced from a predetermined position by 2187.2 mm upward (in the +y axis direction). “Predetermined position” here refers to a position when the vehicle body is not tilted in the front-back direction. Since the magnification is 1250, the amount of shift of the projection lens 4 required to correct the displacement of the optical axis is represented by the following equation (3):

2187.2 mm/1250=1.75 mm (3)

Only by shifting the projection lens 4 by 1.75 mm downward, the displacement of the optical axis can be corrected. That is, the projection lens 4 is translated by 1.75 mm downward. On the contrary, if the front side in the front-back direction of the vehicle body tilts by 5 degrees downward, the projection lens 4 should be shifted (translated) by 1.75 mm upward, contrary to the above description. That is, the projection lens 4 is translated by 1.75 mm upward.

In this manner, the vehicle headlight module 120 according to the fifth embodiment can correct displacement of the optical axis in the up-down direction (y axis direction) due to tilt of the vehicle body in the front-back direction, by slightly shifting (translating) the projection lens 4 in the y axis direction. This eliminates the need for driving the entire vehicle headlight, which has been common up to now. Thus, the load of the driving part is reduced. Further, since the diameter of the projection lens 4 is small, a small and simple optical axis adjuster can be achieved.

The vehicle headlight module 120 according to the fifth embodiment translates the projection lens 4 of the vehicle headlight module 1 according to the first embodiment in the up-down direction (y axis direction) of the vehicle. However, even if the projection lens 4 of any of the vehicle headlight module 10 according to the second embodiment, the vehicle headlight module 100 according to the third embodiment, and the vehicle headlight module 110 according to the fourth embodiment is translated in the up-down direction (y axis direction) of the vehicle, the same advantages are obtained.

Methods of moving the light distribution pattern in the up-down direction with respect to the traveling direction of the vehicle as in the fifth embodiment include the following method. The vehicle headlight module 120 of the fifth embodiment translates the projection lens 4 in the up-down direction (y axis direction) relative to the light guide component 3. However, the same advantages can be obtained by a method of tilting the projection lens 4 in the up-down direction, or a method of rotating the projection lens 4 about an axis that is parallel to the x axis and passes through an optical axis, as a rotational axis.

FIG. 16 is a configuration diagram illustrating a configuration of a vehicle headlight module 121. The vehicle headlight module 120 corrects displacement of the optical axis in the up-down direction (y axis direction) due to tilt of the vehicle body in the front-back direction, by translating the projection lens 4 in the y axis direction. On the other hand, the vehicle headlight module 121 corrects displacement of the optical axis in the up-down direction (y axis direction) due to tilt of the vehicle body in the front-back direction, by rotating the projection lens 4 about a rotational axis parallel to the x axis.

Differences from the vehicle headlight module 120 will be described. The projection lens 4 has a rotational axis 740 parallel to the x axis. In FIG. 16, since the rotational axis 740 is viewed from the axis direction, it is represented by a black dot. In FIG. 16, the rotational axis 740 extends in the direction perpendicular to the drawing sheet. The projection lens 4 also has, at the end on the −y axis direction side, a worm wheel 730. The worm wheel 730 rotates about the rotational axis 740 integrally with the projection lens 4.

The worm wheel 730 meshes with a worm 720. The worm 720 is mounted on a rotation shaft of a stepping motor 71. When the rotation shaft of the stepping motor 71 rotates, the worm 720 rotates about an axis. As the worm 720 rotates, the worm wheel 730 rotates about the rotational axis 740. As the worm wheel 730 rotates about the rotational axis 740, the projection lens 4 rotates about the rotational axis 740.

As viewed from the +x axis direction, if the projection lens 4 is rotated clockwise about the rotational axis 740, the light distribution pattern on the irradiated surface 9 moves downward (in the −y axis direction). On the contrary, if the projection lens 4 is rotated counterclockwise about the rotational axis 740, the light distribution pattern on the irradiated surface 9 moves upward (in the +y axis direction). “About the rotational axis” refers to “with the rotational axis as a center.” This method makes it possible to easily move the light distribution pattern on the irradiated surface 9 in the up-down direction, as compared to the vehicle headlight module 120. This is because this method moves only the projection lens 4 and rotating a part can be performed smoothly with a small driving force as compared to translating the part.

The vehicle headlight module 120 moves the projection lens 4 in a direction corresponding to the up-down direction (y axis direction) of the light distribution pattern relative to the emitting surface 32 of the light guide component 3.

The vehicle headlight module 120 rotates the projection lens 4 about a straight line that passes through the optical axis of the projection lens 4, is perpendicular to the optical axis, and is parallel to the left-right direction (x axis direction) of the light distribution pattern, as a rotational axis.

### Sixth Embodiment

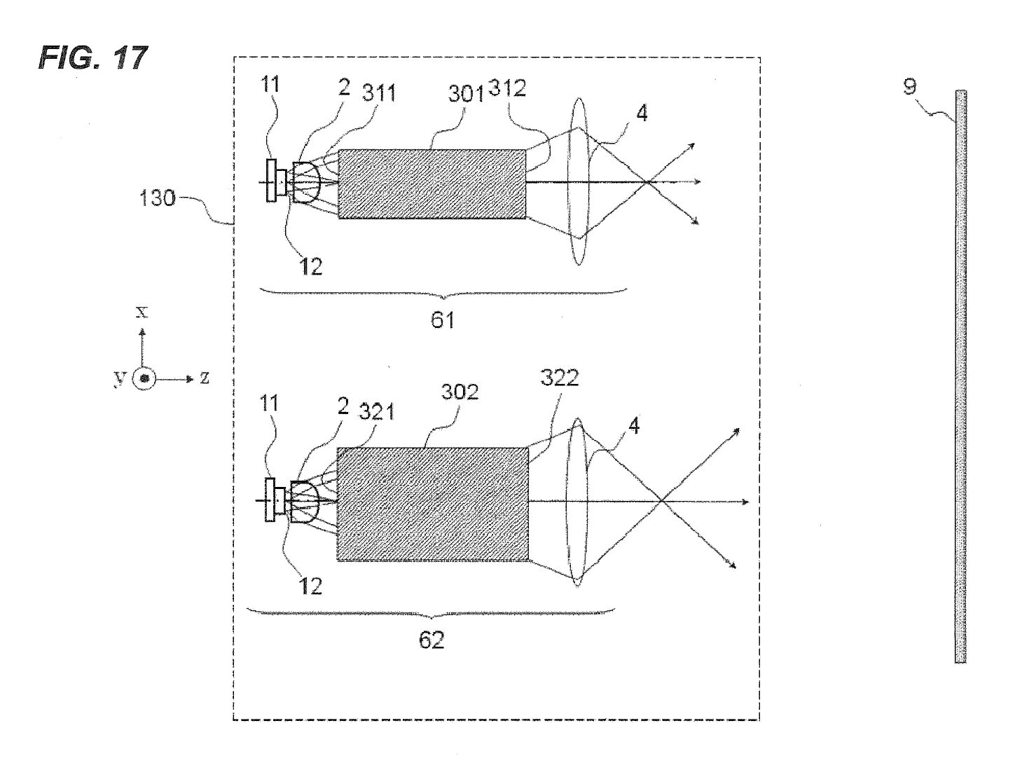

FIG. 17 is a configuration diagram illustrating a configuration of a vehicle headlight device 130 according to a sixth embodiment of the present invention. In the sixth embodiment, for example, the vehicle headlight device 130 is configured by arranging a plurality of the vehicle headlight modules 1 of the first embodiment in the x axis direction. In FIG. 17, the vehicle headlight device 130 includes two vehicle headlight modules 61 and 62. The two vehicle headlight modules 61 and 62 are arranged in the x axis direction. The vehicle headlight modules 61 and 62 emit light in the +z axis direction. By adding light distributions of light emitted from the respective vehicle headlight modules 61 and 62, a desired light distribution pattern is obtained. “Desired” here refers to, for example, satisfying road traffic rules or the like. The vehicle headlight device 130 according to the sixth embodiment forms a light distribution pattern of a low beam of a motorcycle headlight by using the two vehicle headlight modules 61 and 62, for example.

In FIG. 17, elements that are the same as in FIG. 1 will be given the same reference characters, and descriptions thereof will be omitted. The elements that are the same as in FIG. 1 are the light sources 11, light distribution control lenses 2, light guide components 301 and 302, and projection lenses 4. The light guide components 301 and 302 have reference characters different from that of the light guide component 3 of the first embodiment, and different reference characters are used for the vehicle headlight modules 61 and 62 to facilitate understanding. The light guide components 301 and 302 illustrated in the sixth embodiment may have different shapes to form different light distribution patterns. Alternatively, the light guide components 301 and 302 may have the same shape. The light guide components 301 and 302 represented in FIG. 17 have different shapes to form different light distribution patterns. As in the first embodiment, the light sources 11 will also be referred to as the LEDs 11. The vehicle headlight device 130 according to the sixth embodiment includes the vehicle headlight modules 61 and 62. The configurations of the vehicle headlight modules 61 and 62 are the same as that of the vehicle headlight module 1 of the first embodiment.

Components of the vehicle headlight module 61 and components of the vehicle headlight module 62 have the same shape except for the light guide components 301 and 302. Specifically, the vehicle headlight modules 61 and 62 employ the same LED 11, light distribution control lens 2, and projection lens 4. Thus, only by replacing the light guide component 301 in the vehicle headlight module 61 with the light guide component 302, the vehicle headlight module 62 can be made.

In the vehicle headlight module 61, light emitted from the light emitting surface 12 of the LED 11 is incident on the light distribution control lens 2. The light distribution control lens 2 reduces the divergence angle of the light emitted from the LED 11. Thus, the divergence angle of the light emitted from the light distribution control lens 2 is smaller than the divergence angle of the light emitted from the LED 11. The light emitted from the light distribution control lens 2 enters the light guide component 301 through an incident surface 311. The light entering the light guide component 301 propagates inside the light guide component 301 while being reflected, and thereby becomes planar light having a light intensity distribution with increased uniformity. Thus, the light becomes planar light with enhanced uniformity on an emitting surface 312. As in the first embodiment, since an inclined surface (not illustrated) is provided on the −y axis direction side of the emitting surface 312, the luminous intensity of the lower end portion (not illustrated) of the emitting surface 312 is high. The light emitted from the emitting surface 312 passes through the projection lens 4 and then is radiated to the irradiated surface 9.

In the vehicle headlight module 62, light emitted from the light emitting surface 12 of the LED 11 is incident on the light distribution control lens 2. The light distribution control lens 2 reduces the divergence angle of the light emitted from the LED 11. Thus, the divergence angle of the light emitted from the light distribution control lens 2 is smaller than the divergence angle of the light emitted from the LED 11. The light emitted from the light distribution control lens 2 enters the light guide component 302 through an incident surface 321. The divergence angle of the light emitted from the light distribution control lens 2 in the vehicle headlight module 62 is the same as the divergence angle of the light emitted from the light distribution control lens 2 in the vehicle headlight module 61. The light entering the light guide component 302 propagates inside the light guide component 302 while being reflected, and thereby becomes planar light having a light intensity distribution with increased uniformity. Thus, the light becomes planar light with enhanced uniformity on an emitting surface 322. Since the area of the emitting surface 322 is larger than the area of the emitting surface 312, the light guide component 302 emits, to the projection lens 4, planar light wider than that of the light guide component 301. As in the first embodiment, since an inclined surface (not illustrated) is provided on the −y axis direction side of the emitting surface 322, the luminous intensity of the lower end portion (not illustrated) of the emitting surface 322 is high. The light emitted from the emitting surface 322 passes through the projection lens 4 and then is radiated to the irradiated surface 9.

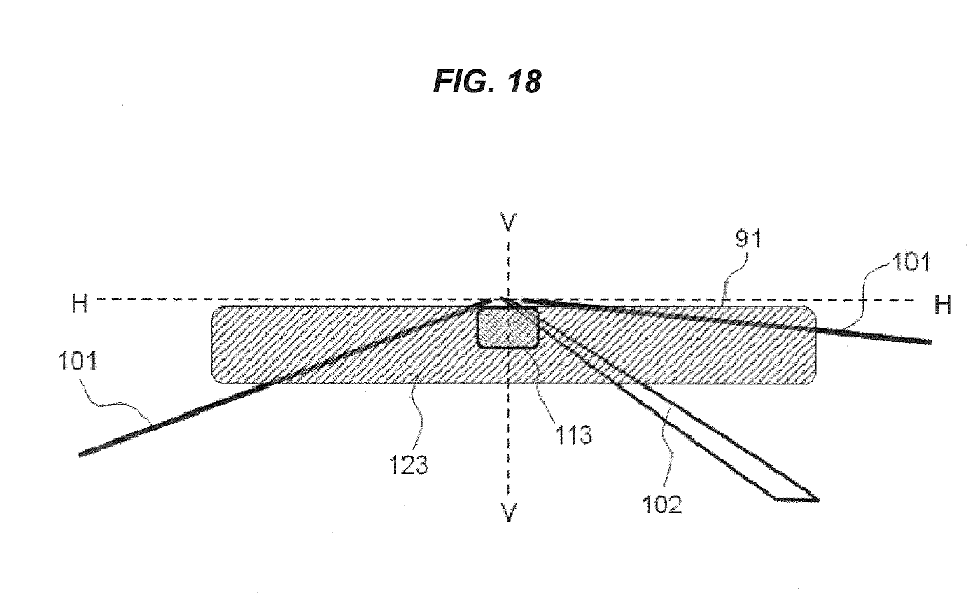

FIG. 18 is a schematic diagram illustrating irradiated areas 113 and 123 on the irradiated surface irradiated by the vehicle headlight modules 61 and 62. The irradiated areas 113 and 123 are light distribution patterns of the respective vehicle headlight modules 61 and 62. The vehicle headlight module 61 irradiates the irradiated area 113. The vehicle headlight module 62 irradiates the irradiated area 123. As can be seen from FIG. 18, the vehicle headlight module 61 irradiates the irradiated area 113 near a center of the light distribution pattern, just beneath the cutoff line 91, and on the irradiated surface 9. This portion is required to have the highest illuminance in the irradiated area. On the other hand, the vehicle headlight module 62 irradiates the wide irradiated area 123 on the irradiated surface 9. The irradiated area 123 has a light distribution pattern similar to the light distribution pattern 103 described in the first embodiment.

The emitting surface 312 of the light guide component 301 of the vehicle headlight module 61 has, for example, a square shape with a height of 1.0 mm (in the y axis direction) and a width of 1.0 mm (in the x axis direction). The vehicle headlight module 62 has, for example, a rectangular shape with a height of 2.0 mm and a width of 15.0 mm.

The projection lens 4 of the vehicle headlight module 61 and the projection lens 4 of the vehicle headlight module 62 are the same. Thus, if the distance from the emitting surface 312 of the light guide component 301 to the projection lens 4 and the distance from the emitting surface 322 of the light guide component 302 to the projection lens 4 are the same, the magnifications at which the light is magnified and projected onto the irradiated surface 9 are the same. Thus, the irradiated surface 9 is irradiated while the area ratio and luminous intensity ratio between the emitting surface 312 of the light guide component 301 of the vehicle headlight module 61 and the emitting surface 322 of the light guide component 302 of the vehicle headlight module 62 are maintained on the irradiated surface 9. The area ratio and luminous intensity ratio between the emitting surface 312 and the emitting surface 322 are magnified and radiated onto the irradiated surface 9.

If the output of light from the LED 11 of the vehicle headlight module 61 and the output of light from the LED 11 of the vehicle headlight module 62 are the same, the illuminance per unit area on the irradiated surface 9 of the vehicle headlight module 61 is larger than that of the vehicle headlight module 62. This is because the area of the emitting surface 312 of the vehicle headlight module 61 is smaller than the area of the emitting surface 322 of the vehicle headlight module 62.

The vehicle headlight module 61 irradiates the irradiated area 113 that is on the irradiated surface 9, at a center of the light distribution pattern, and just beneath the cutoff line 91. The vehicle headlight module 61 irradiates a part that is required to have the highest illuminance. The vehicle headlight module 62 irradiates the wide irradiated area 123 on the irradiated surface 9. The vehicle headlight module 62 effectively illuminates a wide area on the irradiated surface 9 at a generally low illuminance.

In this manner, the vehicle headlight device 130 uses the multiple vehicle headlight modules 61 and 62, and adds their light distribution patterns to form a desired light distribution pattern. “Desired” here refers to satisfying road traffic rules or the like. Optical components other than the light guide components 300 and 310 can be made common between the vehicle headlight modules 61 and 62. In the past, the optical system has been optimally designed for each vehicle headlight module. Thus, it has been difficult to make optical components common. In the vehicle headlight device 130 according to the sixth embodiment of the present invention, optical components other than the light guide components 300 and 310 can be made common between the respective vehicle headlight modules. This is because the light distribution pattern can be formed by at least the shapes of the light guide components 300 and 310. Thus, only by replacing the light guide components 300 and 310, different light distribution patterns can be formed. Thus, according to the vehicle headlight device 130, the number of types of optical components can be reduced. Further, according to the vehicle headlight device 130, management of the optical components can be facilitated. Thus, according to the vehicle headlight device 130, the manufacturing cost can be reduced.

In the vehicle headlight device 130 according to the sixth embodiment, only the light guide components are different between the multiple vehicle headlight modules. However, this is not mandatory. For example, the LEDs 11 may be different between the vehicle headlight modules. Accordingly, the light distribution control lenses 2 may have different specifications corresponding to the shapes and sizes of the LEDs 11.

In the sixth embodiment, the geometric distance from the emitting surface 312 of the light guide component 301 to the projection lens 4 in the vehicle headlight module 61 and the geometric distance from the emitting surface 322 of the light guide component 302 to the projection lens 4 in the vehicle headlight module 62 are the same. The specifications of the projection lenses 4 of the vehicle headlight modules 61 and 62 are the same. The reason for this is as follows. The projection lenses 4 are designed to image light emitted from the emitting surfaces 312 and 322 of the light guide components 301 and 302 onto the predetermined irradiated surface 9. “Predetermined” here refers to being specified in road traffic rules or the like. Thus, if the geometric positional relationship between the projection lens 4 and the emitting surface 312 or 322 is shifted, the light emitted from the emitting surface 312 or 322 cannot be magnified and projected onto the irradiated surface 9 at a desired magnification. “Desired magnification” here refers to a magnification for satisfying road traffic rules or the like. Further, the projection lenses 4 are typically aspherical lenses or free-form surface lenses. Thus, the projection lenses 4 have complicated surface shapes, are difficult to manufacture, take much time to manufacture, and therefore requires high manufacturing costs. Manufacturing multiple types of projection lenses 4 further complicates the management and manufacture of parts and greatly affects the cost of the product. Thus, it is desirable that the projection lenses 4 be common between the vehicle headlight modules.

In the vehicle headlight device 130 according to the sixth embodiment, a low beam for a motorcycle is described. However, this is not mandatory. The vehicle headlight device employing the multiple vehicle headlight modules using the different light guide components is applicable to other vehicle headlights. Further, in the vehicle headlight device 130 according to the sixth embodiment, a case where the number of vehicle headlight modules is two is described as an example. However, the number is not limited to two as long as a light distribution pattern of a vehicle headlight can be formed. The number of vehicle headlight modules may be three or more.

In the vehicle headlight device 130 according to the sixth embodiment, a plurality of the vehicle headlight module 1 according to the first embodiment are arranged as the vehicle headlight modules. However, this is not mandatory, and the same advantages are obtained if a plurality of any of the vehicle headlight modules 10, 100, 110, 120, and 121 according to the second to fifth embodiments are arranged as the vehicle headlight modules. In a case where the configuration of the vehicle headlight module 100 is employed, when the vehicle tilts left and right, an appropriate light distribution pattern can be formed by rotating a subset of the vehicle headlight modules about an optical axis.

The vehicle headlight device 130 includes the vehicle headlight module 1, 10, 100, 110, 120, 121, or a vehicle headlight unit 140 described in a seventh embodiment.

The vehicle headlight device 130 includes a plurality of the vehicle headlight modules 1, 10, 100, 110, 120, 121, or the vehicle headlight units 140 described in the seventh embodiment. The vehicle headlight device 130 forms a single light distribution pattern by combining the light distribution patterns of the respective vehicle headlight modules 1, 10, 100, 110, 120, or 121, or the light distribution patterns of the vehicle headlight units 140.

### Seventh Embodiment

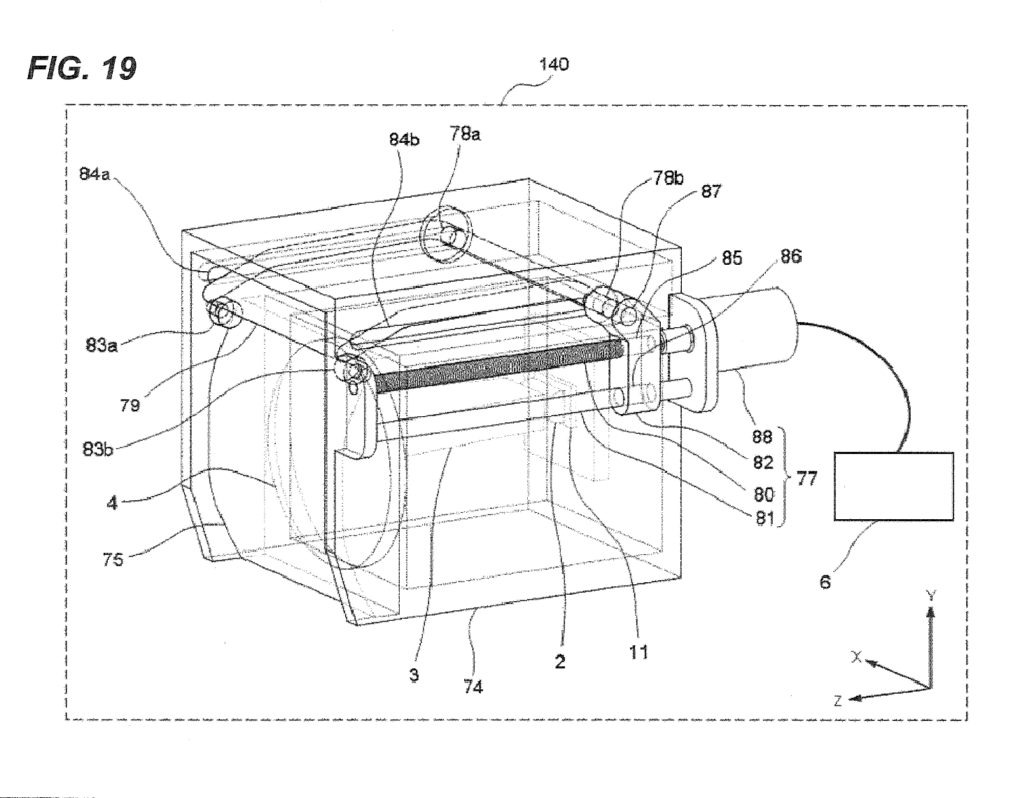

FIG. 19 is a configuration diagram illustrating a configuration of the vehicle headlight unit 140 according to the seventh embodiment of the present invention. Elements that are the same as in FIG. 1 will be given the same reference characters, and descriptions thereof will be omitted. The elements that are the same as in FIG. 1 are the light source 11, light distribution control lens 2, light guide component 3, and projection lens 4. As in the first embodiment, the light source 11 will also be referred to as the LED 11.

As illustrated in FIG. 19, the vehicle headlight unit 140 according to the seventh embodiment includes the LED 11, light guide component 3, projection lens 4, and a cover shade 79. The vehicle headlight unit 140 may also include a housing case 74, a module cover 75, a translation/rotation mechanism 77, and a control circuit 6. The vehicle headlight unit 140 may also include the light distribution control lens 2. The vehicle headlight unit 140 will be described on the assumption that it is obtained by mounting the vehicle headlight module 1 described in the first embodiment on the housing case 74. The housing case 74 may include the vehicle headlight module 10, 100, 110, 120, or 121 instead of the vehicle headlight module 1. Specifically, the vehicle headlight unit 140 according to the seventh embodiment is obtained by mounting, on the vehicle headlight module 1 according to the first embodiment, the housing case 74, module cover 75, cover shade 79, translation/rotation mechanism 77, and control circuit 6.

Typically, a vehicle headlight is mounted on a housing case or the like in order to be mounted on a vehicle. “Housing case” refers to, among chassis components of machines, a covering component that encloses and protects a device or the like. The vehicle headlight module 1 is mounted on the vehicle while covered by the housing case 74.

A surface of the housing case from which light is emitted is covered by resin that transmits light. Thus, a portion through which light is emitted from the housing case to the outside is covered with a cover. “Surface from which light is emitted” refers to a portion (region) of the housing case that transmits light emitted from the vehicle headlight module. The module cover 75 covers the surface of the housing case 74 from which light is emitted. Thus, the module cover 75 corresponds to the above-described cover. Resin that transmits light is referred to as transmissive resin. Transmissive resin may turn yellow mainly due to ultraviolet light. For example, transmissive resin turns yellow when it is exposed to direct sunlight. The same phenomenon may occur in a vehicle headlight mounted on a vehicle. In the case of a vehicle headlight, yellowing of transmissive resin decreases the light transmittance. Thus, the yellowing makes it difficult for the vehicle headlight to provide the brightness that the vehicle headlight can provide originally. The yellowing also decreases the design of the vehicle headlight.

The vehicle headlight unit 140 according to the seventh embodiment solves such a problem with a small and simple configuration.

The cover shade 79 is a component that covers the front of the module cover 75 to prevent yellowing of the module cover 75, i.e., a component that covers the front of the module cover 75. “Front of the module cover 75” refers to the +z axis side of the module cover 75, i.e., the outer side of the module cover 75. When the vehicle headlight is used, the cover shade 79 is retracted from the front of the module cover 75. In FIG. 19, the cover shade 79 is retracted from the front of the module cover 75. Typically, the cover shade 79 is in this position when the module cover 75 is not subjected to ultraviolet light during the night. When the vehicle headlight is not used, the cover shade 79 covers the front of the module cover 75. Typically, the cover shade 79 is in this position when the module cover 75 is subjected to ultraviolet light during the day.

The translation/rotation mechanism 77 is a mechanism for moving the cover shade 79. The translation/rotation mechanism 77 translates the cover shade 79 along an optical axis (z axis direction). In FIG. 19, the translation/rotation mechanism 77 is translating the cover shade 79 along the optical axis (z axis direction) in a state where the cover shade 79 is retracted from the front of the module cover 75. The translation/rotation mechanism 77 also rotates the cover shade 79 about an axis that is perpendicular to the optical axis and extends in the left-right direction, as a rotational axis. That is, the translation/rotation mechanism 77 rotates the cover shade 79 about an axis parallel to the x axis. The translation/rotation mechanism 77 covers the module cover 75 with the cover shade 79 or retracts the cover shade 79 from the front of the module cover 75 by translating and rotating the cover shade 79.

The cover shade 79 has, on its side surfaces (+x axis direction side and −x axis direction side), pins 78a and 78b. The pin 78a is mounted on the side surface on the +x axis direction side of the cover shade 79 so as to project in the +x axis direction. The pin 78b is mounted on the side surface on the −x axis direction side of the cover shade 79 so as to project in the −x axis direction. The pin 78a is inserted in a slot 84a formed in the housing case 74. The pin 78b is inserted in a slot 84b formed in the housing case 74. The slots 84a and 84b are provided in sides of the housing case 74. The slots 84a and 84b are holes elongated in the z axis direction. The cover shade 79 is a plate-shaped component. In a retracted position, the cover shade 79 is arranged on the upper side (+y axis direction side) of the vehicle headlight module 1 in parallel with the z-x plane. Thus, the cover shade 79 is arranged so as to extend in the z-x plane. In this position, the pins 78a and 78b are located at the ends on the −z axis direction side of the cover shade 79.

In the state where the cover shade 79 is retracted, on the lower side (−y axis direction side) of the ends on the +z axis direction side of the cover shade 79, slide rotary pins 83a and 83b are disposed. The slide rotary pins 83a and 83b are rotary shafts parallel to the x axis. The slide rotary pins 83a and 83b are mounted on the inner sides of the housing case 74. A bottom surface of the cover shade 79 is always in contact with the slide rotary pins 83a and 83b. “Bottom surface of the cover shade 79” here refers to a surface on the −y axis direction side of the cover shade 79 in the state where the cover shade 79 is retracted. Thus, in the state where the cover shade 79 is retracted, the cover shade 79 is supported by the pins 78a and 78b and the slide rotary pins 83a and 83b. The slide rotary pins 83a and 83b have a function of rotating and guiding the cover shade 79 when the cover shade 79 moves. To make the bottom surface of the cover shade 79 always in contact with the slide rotary pins 83a and 83b, for example, an upper surface (surface on the +y axis direction side) of the cover shade 79 may be pressed by a spring, which is, for example, a plate spring or the like.

The translation/rotation mechanism 77 includes, for example, a stepping motor 88, a feed screw 80, a slider shaft 81, and a slider 82. The translation/rotation mechanism 77 is mounted on the outer side on the −x axis direction side of the housing case 74. The tip of the pin 78b projects outside the housing case 74 through the slot 84b. The tip of the pin 78b is inserted in a pin hole 87 provided in the slider 82. The pin hole 87 is a hole bored in parallel with the x axis.

The slider 82 further has a threaded hole 85 and a slide hole 86. The threaded hole 85 and slide hole 86 are bored in parallel with the z axis. The feed screw 80 is rotatably inserted in the threaded hole 85 while meshing with the threaded hole 85. The slider shaft 81 is inserted in the slide hole 86. Both ends of the slider shaft 81 are attached to the housing case 74. The slider 82 moves in the z axis direction while guided by the slider shaft 81.

The stepping motor 88 is mounted on the housing case 74. One end of the feed screw 80 is mounted to a shaft of the stepping motor 88. The other end of the feed screw 80 is mounted to the housing case 74. The axes of the feed screw 80 and stepping motor 88 are arranged in parallel with the z axis. The slider 82 moves in the z axis direction by rotation of the feed screw 80. The movement of the slider 82 in the z axis direction moves the cover shade 79 in the z axis direction. When the stepping motor 88 is driven, the shaft of the stepping motor 88 rotates. As the shaft of the stepping motor 88 rotates, the feed screw 80 rotates. As the feed screw 80 rotates, the slider 82 moves in the z axis direction due to meshing of the gear.

The control circuit 6 sends a control signal to the stepping motor 88. The control circuit 6 controls a rotation angle and a rotation speed of the stepping motor 88. The stepping motor 88 may be replaced with a motor such as a DC motor.

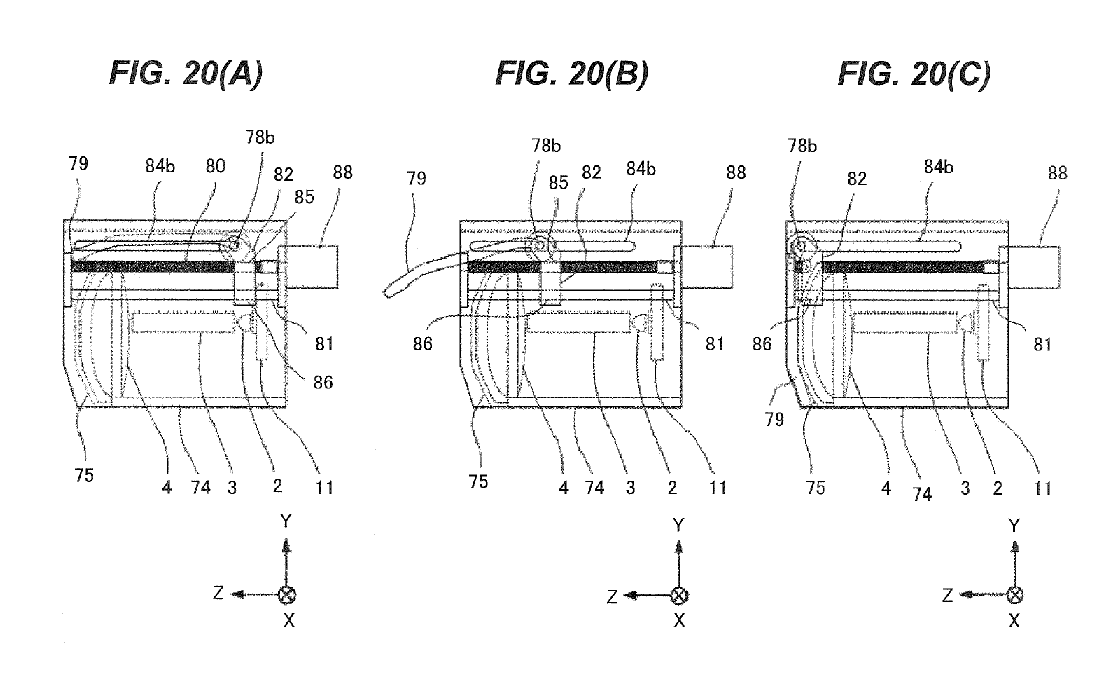

FIGS. 20(A), 20(B), and 20(C) are schematic diagrams for explaining motion of the cover shade 79 according to the seventh embodiment of the present invention. FIGS. 20(A), 20(B), and 20(C) are diagrams of the vehicle headlight unit 140 as viewed from the −x axis direction. FIG. 20(A) illustrates a state where the cover shade 79 is retracted to the upper side (+y axis direction side) of the vehicle headlight unit 140. FIG. 20(C) illustrates a state where the cover shade 79 covers the module cover 75. FIG. 20(B) illustrates a state where the cover shade 79 is shifting from the state of FIG. 20(A) to the state of FIG. 20(C).

In the state of FIG. 20(A), when the stepping motor 88 is driven, the shaft of the stepping motor 88 rotates. As the shaft of the stepping motor 88 rotates, the feed screw 80 rotates. As the feed screw 80 rotates, the slider 82 moves in the +z axis direction due to meshing of the screw. Since the pin 78b of the cover shade 79 is inserted in the pin hole 87 of the slider 82, the cover shade 79 moves in the +z axis direction.

In the state of FIG. 20(B), the cover shade 79 has moved in the +z axis direction by one-half of the length in the z axis direction of the cover shade 79. A half on the +z axis direction side of the cover shade 79 projects from the housing case 74 in the +z axis direction.

In the state of FIG. 20(C), the pin 78a is located on the upper side (+y axis direction side) of the slide rotary pin 83a. Similarly, the pin 78b is located on the upper side (+y axis direction side) of the slide rotary pin 83b. Thus, the pins 78a and 78b and the slide rotary pins 83a and 83b cannot support the cover shade 79 in parallel with the z-x plane. That is, they cannot support the cover shade 79 in a state where the cover shade 79 extends in the z-x plane. Thus, as viewed from the −x axis direction, the cover shade 79 rotates counterclockwise about the pins 78a and 78b. Then, the cover shade 79 becomes parallel to the x-y plane on the +z axis direction side of the module cover 75 and covers the module cover 75. That is, the cover shade 79 covers the module cover 75 on the +z axis direction side of the module cover 75 while extending in the x-y plane.

When the vehicle headlight is used, the slider 82 is moved in the −z axis direction. Thus, the cover shade 79 is moved to the upper side (+y axis direction side) of the vehicle headlight unit 140. In this position, the cover shade 79 does not block light emitted from the vehicle headlight module 1. When the vehicle headlight is not used, the slider 82 is moved in the +z axis direction. Thus, the cover shade 79 is moved in front of the module cover 75. In this position, the cover shade 79 blocks light incident on the vehicle headlight module 1 from the outside.

If the cover shade 79 is made of material that does not transmit light, such as ultraviolet light, yellowing the module cover 75, yellowing of the module cover 75 can be reduced. Further, when the vehicle headlight is not used, the cover shade 79 is located on the outermost side of the vehicle headlight. Thus, for example, if the cover shade 79 has the same color as the vehicle, the degree of freedom of design of the vehicle is high.

The structure for covering the module cover 75 may employ a motion of the cover shade 79 other than the translation and rotation motion. “Translation and rotation motion” refers to motion with translating motion and rotating motion. In the seventh embodiment, the moving motion of the cover shade 79 is arbitrary as long as the module cover 75 can be covered. Further, the position where the cover shade 79 is located in use at night need not be limited to the configuration of the seventh embodiment, as long as it does not block the light from the vehicle headlight. For example, it is possible to employ a structure in which a cover that rotates about the x axis is provided in front of the module cover 75 and the cover is opened and closed. This mechanism use rotating motion. It is also possible to employ a structure in which the cover shade 79 is divided to be arranged on the left and right sides or upper and lower sides of the module cover 75, and is opened like a door by using rotating motion. However, these methods cannot retract the cover shade 79, deteriorating the design when the vehicle headlight is being used.

The translation/rotation mechanism 77 for driving the cover shade 79 is not limited to this. For example, the stepping motor 88 may be replaced with a DC motor or the like. Further, as a mechanism for driving the slider 82 in the z axis direction, a belt and a pulley may be used. Further, as a mechanism for driving the slider 82 in the z axis direction, a link mechanism, a gear mechanism, or the like may be used. Further, the cover shade 79 may be manually operated by using a control cable or the like. “Control cable” refers to one in which an inner cable slides in a tubular outer cable. Control cables are used as a cable for transmitting a motion of a pedal or shift lever to respective parts.

The material of the cover shade 79 should be material that does not transmit light in a wavelength range that causes yellowing of transparent resin. Thus, for example, the cover shade 79 may reduce the transmission amount of ultraviolet light and transmit visible light. Thus, it may transmit at least part of visible light to give transparency to the cover shade 79.

The number of vehicle headlight modules provided in the vehicle headlight unit 140 is not limited to one. Two or more vehicle headlight modules may be provided in one vehicle headlight unit. Even in this case, the advantages of the seventh embodiment can be obtained. Further, there may be a case where the projection lens 4 has a function of the module cover 75. In this case, the cover shade 79 covers the projection lens 4. Further, if a plurality of the cover shade 79 are used, there is no need to necessarily provide a plurality of driving sources (stepping motors 88). The plurality of the cover shade 79 may be driven by an interlocking mechanism.

The vehicle headlight unit 140 includes the vehicle headlight module 1, 10, 100, 110, 120, or 121, and the cover shade 79 that is disposed on a light emitting side of the projection lens 4 of the vehicle headlight module 1, 10, 100, 110, 120, or 121 and reduces the amount of external light reaching the projection lens 4. The cover shade 79 has a first position where it blocks external light reaching the projection lens 4 and a second position where it does not block external light reaching the projection lens 4.

The above-described embodiments use terms, such as “parallel” or “perpendicular”, indicating the positional relationships between parts or the shapes of parts. These terms are intended to include ranges taking account of manufacturing tolerances, assembly variations, or the like. Thus, recitations in the claims indicating the positional relationships between parts or the shapes of parts are intended to include ranges taking account of manufacturing tolerances, assembly variations, or the like.

Although the embodiments of the present invention are described as above, the present invention is not limited to these embodiments.

### DESCRIPTION OF REFERENCE CHARACTERS

10, 100, 110, 120, 121 vehicle headlight module, 130 vehicle headlight device, 140 vehicle headlight unit, 11 light source (LED), 12 light emitting surface, 101 line representing an edge of a road, 102 center line, 103, 106 light distribution pattern, 105 corner area, 113, 123 irradiated area, 2, 20 light distribution control lens, 3, 30, 300, 310 light guide component, 31, 311, 321 incident surface, 32, 312, 322 emitting surface, 32a lower end portion, 32b extended part, 33, 34 inclined surface, 33a lower edge of the emitting surface 32, 35 lower surface, 36 reflecting surface, 4 projection lens, 5 rotation mechanism, 51, 71, 88 stepping motor, 52, 53, 54, 55 gear, 56, 76 shaft, 57 support part, 6 control circuit, 61, 62 vehicle headlight module, 7 translation mechanism, 720 worm, 730 worm wheel, 72 pinion, 73 rack, 73 rack, 74 housing case, 75 module cover, 740 rotational axis, 77 translation/rotation mechanism, 78a, 78b pin, 79 cover shade, 80 feed screw, 81 slider shaft, 82 slider, 83a, 83b slide rotary pin, 84a, 84b slot, 85 threaded hole, 86 slide hole, 87 pin hole, 9 irradiated surface, 91 cutoff line, 94 motorcycle, 95 wheel, 95a position at which the wheel 95 makes contact with the ground, 96 vehicle body tilt sensor, 97 steering angle sensor, 98 vehicle speed sensor, Dᵢₙ incident angle, Dₒᵤₜ emission angle, f₁, f₂ angle, b taper angle, m the number of reflections, k tilt angle, Yh length, IvH, IvL luminous intensity.

1. A vehicle headlight module comprising:
a light source that emits light that becomes illumination light;
a light guide component having an incident surface through which the light emitted from the light source enters the light guide component as incident light, a side surface that reflects the incident light to superpose beams of the incident light, and an emitting surface from which the reflected incident light is emitted; and
a projection lens that projects the light emitted from the emitting surface,
wherein the light guide component has an inclined surface in the side surface, and
wherein a part of the incident light that has been reflected by the inclined surface is superposed with another part of the incident light that has not been reflected by the inclined surface in a partial region on the emitting surface, so that a luminance of the partial region is higher than a luminance of the other region.

2. The vehicle headlight module of claim 1, wherein the inclined surface is formed by chamfering an edge of the emitting surface.

3. A vehicle headlight module comprising:
a light source that emits light that becomes illumination light;
a light guide component having an incident surface through which the light emitted from the light source enters the light guide component as incident light, a side surface that reflects the incident light to superpose beams of the incident light, and an emitting surface from which the reflected incident light is emitted; and
a projection lens that projects the light emitted from the emitting surface,
wherein the light guide component has an inclined surface in the side surface, and
wherein a part of the incident light travels straight without being reflected at a position of the inclined surface and exits from a partial region on the emitting surface, so that a luminance of the partial region is lower than a luminance of the other region.

4. The vehicle headlight module of claim 3, wherein the inclined surface is connected to an edge of the emitting surface, and is inclined to increase the area of the emitting surface.

5. A vehicle headlight module comprising:
a light source that emits light that becomes illumination light;
a light guide component having an incident surface through which the light emitted from the light source enters the light guide component as incident light, a side surface that reflects the incident light to superpose beams of the incident light, and an emitting surface from which the reflected incident light is emitted; and
a projection lens that projects the light emitted from the emitting surface,
wherein the light guide component has an inclined surface in the side surface, and
wherein an optical path of the incident light defined by the inclined surface causes a difference in luminance between a partial region of the emitting surface and the other region.

6. The vehicle headlight module of claim 1, further comprising a light distribution control lens that receives the light emitted from the light source,
wherein the light emitted from the light source has a first divergence angle, and
wherein the light distribution control lens receives the light having the first divergence angle and emits light having a second divergence angle smaller than the first divergence angle.

7. The vehicle headlight module of claim 6, wherein the light distribution control lens has a toroidal lens surface, a curvature of the light distribution control lens in a direction corresponding to an up-down direction of a light distribution pattern of the light projected from the projection lens being larger than a curvature of the light distribution control lens in a direction corresponding to a horizontal direction of the light distribution pattern,
wherein in the up-down direction of the light distribution pattern, the light distribution control lens receives the light emitted from the light source and having the first divergence angle, and emits light having the second divergence angle smaller than the first divergence angle,
wherein a side surface of the light guide component corresponding to the horizontal direction of the light distribution pattern has a taper such that the emitting surface is larger than the incident surface, and
wherein the light guide component receives the light emitted from the light distribution control lens through the incident surface, and in the horizontal direction of the light distribution pattern, emits light having a divergence angle smaller than a divergence angle of the received light from the emitting surface.

8. The vehicle headlight module of claim 7, wherein the light distribution control lens is a cylindrical lens having curvature in a direction corresponding to the up-down direction of the light distribution pattern.

9. The vehicle headlight module of claim 1, wherein the light source is fixed, and the vehicle headlight module rotates the light guide component about an axis parallel to an optical axis as a rotational axis.

10. The vehicle headlight module of claim 1, wherein the light source is fixed, and the vehicle headlight module rotates the projection lens about an axis parallel to an optical axis as a rotational axis.

11. The vehicle headlight module of claim 1, wherein the light guide component has, between the incident surface and the emitting surface, a reflecting surface that bends a traveling path of light ahead of a vehicle, and
wherein the light source is fixed, and the vehicle headlight module rotates the light guide component and the projection lens about an optical axis on the incident surface as a rotational axis.

12. The vehicle headlight module of claim 1, wherein the light source is fixed, and the vehicle headlight module moves the projection lens relative to the emitting surface of the light guide component in a direction corresponding to an up-down direction of a light distribution pattern of the light projected from the projection lens.

13. The vehicle headlight module of claim 1, wherein the light source is fixed, and the vehicle headlight module rotates the projection lens about a straight line that passes through an optical axis of the projection lens, is perpendicular to the optical axis, and is parallel to a left-right direction of a light distribution pattern of the light projected from the projection lens, as a rotational axis.

14. A vehicle headlight unit comprising:
the vehicle headlight module of claim 1; and
a cover shade that is disposed on a light emitting side of the projection lens of the vehicle headlight module, and reduces the amount of external light reaching the projection lens,
wherein the cover shade has a first position where the cover shade blocks the external light reaching the projection lens and a second position where the cover shade does not block the external light reaching the projection lens.

15. A vehicle headlight device comprising the vehicle headlight module of claim 1.

16. A vehicle headlight device comprising a plurality of the vehicle headlight modules of claim 1,
wherein the vehicle headlight device combines light distribution patterns of the respective vehicle headlight modules or light distribution patterns of the vehicle headlight units to form a single light distribution pattern.
